(19) United States
(12) Patent Application Publication
(10) Pub. No.: US 2026/0188193 A1
(43) Pub. Date: Jul. 2, 2026

(54) DISPLAY DEVICE

(71) Applicant: LG Display Co., Ltd., Seoul (KR)

(72) Inventors: ChangSeok OH, Daegu (KR); SangGyu KIM, Gumi-si (KR); Yeonji RYU, Andong-si (KR)

(73) Assignee: LG Display Co., Ltd., Seoul (KR)

(21) Appl. No.: 19/380,382

(22) Filed: Nov. 5, 2025

(30) Foreign Application Priority Data
Dec. 30, 2024 (KR) 10-2024-0200547

(51) Int. Cl. G09G 3/32; G09G 3/3233

(52) U.S. Cl. CPC G09G 3/32; G09G 3/3233; G09G 2300/0426; G09G 2300/0814; G09G 2300/0871; G09G 2310/08; G09G 2380/10

(57) ABSTRACT

A display device according to one or more aspects, includes a timing controller for outputting a mode selection signal, a level shifter for outputting a first mode signal and a second mode signal based on the mode selection signal, a first light emitting diode configured to be driven based on the first mode signal, a first optical member disposed on the first light emitting diode, a second light emitting diode configured to be driven based on the second mode signal, a second optical member disposed on the second light emitting diode and having a shape different from a shape of the first optical member, and a detection circuit configured to detect whether the level shift, a first mode or a second mode operates normally based on at least two of the first mode signal, the second mode signal and the mode selection signal.

### CROSS-REFERENCE TO RELATED APPLICATIONS

This application claims the benefit of and priority to Korean Patent Application No. 10-2024-0200547 filed on Dec. 30, 2024, in the Korean Intellectual Property Office, the entire contents of which are incorporated herein by reference for all purposes.

### BACKGROUND

### 1. Technical Field

The present disclosure relates to a display device, and particularly to, for example, without limitation, a display device which detects whether a level shifter, a first mode, and a second mode normally operate.

### 2. Description of Related Art

As the technology in modern society develops, display devices are used in various ways to provide information to users. The display devices are included in not only electronic signs which simply transmit visual information in one direction, but also various electronic devices which require a higher level of technology to check user's input and provide information in response to the checked input.

For example, a display device is included in a vehicle to provide various information to a driver and a passenger of the vehicle. However, the display device for the vehicle needs to appropriately display contents without interrupting the operation of the vehicle. For example, the display device needs to limit the display of the contents which may reduce the concentration on the driving while the vehicle is in operation.

The description of related art should not be considered prior art merely because it is mentioned in or associated with this section. The description of related art includes information that describes one or more aspects of the subject technology, and the description in this section does not limit the scope of the present disclosure.

### SUMMARY

An aspect of the present disclosure is to provide a display device which independently detects whether each mode normally operates during a mode-selective operation.

Another aspect of the present disclosure is to provide a display device which independently detects whether a level shifter which receives a selection signal output from the timing controller normally operates.

Aspects of the present disclosure are not limited to the above-mentioned aspects, and other aspects, which are not mentioned above, can be clearly understood by those skilled in the art from the following descriptions.

A display device according to an aspect of the present disclosure, comprises a timing controller for outputting a mode selection signal, a level shifter for outputting a first mode signal and a second mode signal based on the mode selection signal, a first light emitting diode configured to be driven based on the first mode signal, a first optical member disposed on the first light emitting diode, a second light emitting diode configured to be driven based on the second mode signal, a second optical member disposed on the second light emitting diode and having a shape different from a shape of the first optical member, and a detection circuit configured to detect whether the level shift, a first mode or a second mode operates normally based on at least two of the first mode signal, the second mode signal and the mode selection signal.

A display device according to another aspect of the present disclosure, comprises a timing controller for outputting a mode selection signal, a mode selection signal line for transmitting the mode selection signal, a level shifter connected to the mode selection signal line and for outputting a first mode signal and a second mode signal, a first connection line for transmitting the first mode signal, a second connection line for transmitting the second mode signal, a plurality of first mode signal lines connected to the first connection line and for transmitting the first mode signal to the plurality of first light emitting diodes, a plurality of second mode signal lines connected to the second connection line and for transmitting the second mode signal to the plurality of second light emitting diodes, a plurality of first optical members disposed so as to correspond to the plurality of first light emitting diodes, a plurality of second optical members disposed so as to correspond to the plurality of second light emitting diodes, one or more detection lines among a first detection line connected to the plurality of first mode signal lines to transmit the first mode signal to a detection circuit and a second detection line connected to the plurality of second mode signal lines to transmit the second mode signal to the detection circuit, and the detection circuit for receiving at least one of the first mode signal and the second mode signal from the one or more detection lines.

Other detailed matters of the example embodiments are included in the detailed description and the drawings.

According to the present disclosure, in a display device which is driven in a first mode and a second mode, an erroneous operation of the first mode and the second mode may be independently detected.

According to the present disclosure, it is possible to independently inspect whether a level shifter outputs an accurate signal according to a signal transmitted from the timing controller.

The effects according to the present disclosure are not limited to the contents exemplified above, and more various effects are included in the present specification.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is an example view of a display device according to an example embodiment of the present disclosure;

FIG. 2 is a functional block diagram of a display device according to an example embodiment of the present disclosure;

FIG. 3 is a circuit diagram illustrating an example of a pixel circuit included in a display device according to an example embodiment of the present disclosure;

FIG. 4 is an enlarged plan view illustrating placement of an optical member included in a display device according to an example embodiment of the present disclosure;

FIG. 5 is a cross-sectional view illustrating an example taken along the line A-A′ of FIG. 4;

FIG. 6 is a cross-sectional view illustrating an example taken along the line B-B′ of FIG. 4;

FIG. 7 is a schematic plan view of a display device according to an example embodiment of the present disclosure;

FIG. 8 is a schematic plan view of a display device according to another example embodiment of the present disclosure;

FIG. 9 is a schematic plan view of a display device according to still another example embodiment of the present disclosure;

FIG. 10 is a schematic plan view of a display device according to still another example embodiment of the present disclosure; and

FIG. 11 is a schematic plan view of a display device according to still another example embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Advantages and characteristics of the present disclosure and a method of achieving the advantages and characteristics will be clear by referring to example embodiments described below in detail together with the accompanying drawings. However, the present disclosure is not limited to the example embodiments disclosed herein but will be implemented in various forms. The example embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the example embodiments of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including”, “having”, and “consist of” used herein are generally intended to allow other components to be added unless the terms are used with the term “only”. Any references to singular may include plural unless expressly stated otherwise. In one or more examples, unless expressly stated otherwise, an element may be one or more elements; and an element may include a plurality of elements.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used to refer to one element separately from another. Therefore, a first component to be mentioned below may be a second component in a technical concept of the present disclosure.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, a display device according to example embodiments of the present disclosure will be described in detail with reference to accompanying drawings.

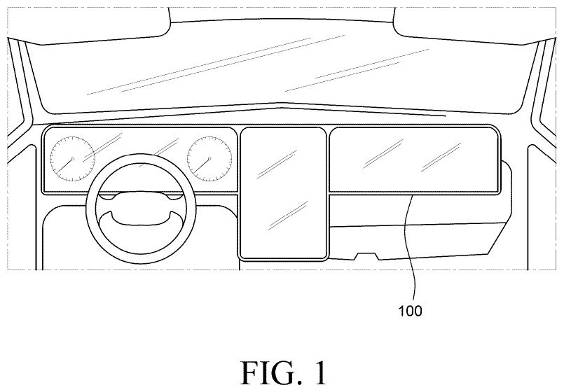

FIG. 1 is an example view of a display device according to an example embodiment of the present disclosure.

Referring to FIG. 1, the display device 100 may be disposed in at least a part of a dashboard of a vehicle. The dashboard of the vehicle may include a configuration disposed in a front surface of front seats (for example, a driver seat and a front passenger seat) of the vehicle. For example, on the dashboard of the vehicle, an input configuration for manipulating various functions (for example, an air-conditioner, an audio system, or a navigation system) in the vehicle may be disposed.

The display device 100 is disposed on the dashboard of the vehicle to operate as an input unit which manipulates at least some of various functions of the vehicle. The display device 100 may provide various information related to the vehicle, for example, operation information of the vehicle (for example, a current speed of the vehicle, a remaining fuel amount, or a mileage) or information about parts of the vehicle (for example, a damage level of a vehicle tire).

The display device 100 may be disposed across the driver seat and the front passenger seat disposed in the front seats of the vehicle. A user of the display device 100 may include a driver of the vehicle and a passenger riding on the front passenger seat. Both the vehicle driver and the passenger may use the display device 100.

Only a part of the display device 100 is illustrated in FIG. 1. The display device 100 illustrated in FIG. 1 represents a display panel, among various configurations included in the display device 100. Specifically, for example, the display device 100 illustrated in FIG. 1 may represent at least a part of an active area and a non-active area of the display panel. Among the configurations of the display device 100, configurations other than the parts illustrated in FIG. 1 may be mounted inside the vehicle (or at least a part of the inside of the vehicle).

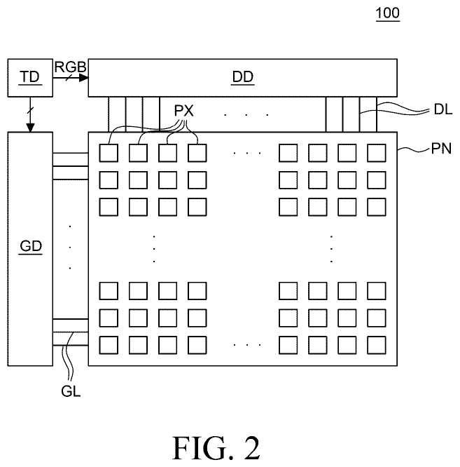

FIG. 2 is a functional block diagram of a display device according to an example embodiment of the present disclosure.

As the display device according to the example embodiment of the present disclosure, an electroluminescent display device may be applied. The electroluminescent display device may use an organic light emitting diode (OLED) display device, a quantum dot light emitting diode display device, or an inorganic light emitting diode display device.

Referring to FIG. 2, the display device 100 may include a display panel PN, a data driving circuit DD, a gate driving circuit GD, and a timing controller TD.

The display panel PN may generate images to be provided to the user. For example, the display panel PN may generate and display images to be provided to the user through a plurality of pixels PX in which the pixel circuits are disposed.

The data driving circuit DD, the gate driving circuit GD, and the timing controller TD may supply signals for an operation of each pixel PX through signal lines. For example, signal lines for supplying a signal for an operation of each pixel PX may include a plurality of data lines DL and a plurality of gate lines GL.

The plurality of data lines DL is disposed in a column direction and may include a plurality of wiring lines connected to pixels PX disposed in one column direction and the plurality of gate lines GL is disposed in a row direction and may include a plurality of wiring lines connected to pixels PX disposed in one row direction.

In some cases, the display device 100 may further include a power unit. In this case, a signal for an operation of the pixel PX may be supplied through the power line which connects the power unit and the display panel PN. According to the example embodiment, the power unit may supply a power to the data driving circuit DD and the gate driving circuit GD. The data driving circuit DD and the gate driving circuit GD may be driven based on the power supplied from the power unit.

For example, the data driving circuit DD may apply a data signal to each pixel PX through the plurality of data lines DL. The gate driving circuit GD may apply a gate signal to each pixel PX through the plurality of gate lines GL. The power unit may supply a power voltage to each pixel PX through the power voltage supply lines.

The timing controller TD may control the data driving circuit DD and the gate driving circuit GD. For example, the timing controller TD rearranges digital video data input from the outside in accordance with a resolution of the display panel PN to supply the digital video data to the data driving circuit DD.

The data driving circuit DD converts digital video data input from the timing controller TD into an analog data voltage based on the data control signal to supply the converted analog data voltage to the plurality of data lines DL.

The gate driving circuit GD may generate a scan signal and an emission signal based on the gate control signal. For example, the gate driving circuit GD may include a scan driver and an emission signal driver. The scan driver generates a scan signal in a row sequential manner to drive at least one or more scan lines connected to each pixel row to supply the scan signal to the scan lines. The emission signal driver generates an emission signal in a row sequential manner to drive at least one or more emission signal lines connected to each pixel row to supply the emission signal to the emission signal lines.

According to the example embodiment, the gate driving circuit GD may be disposed in the display panel PN in a gate-driver in panel (GIP) manner. For example, the gate driving circuit GD is divided into a plurality of circuits to be disposed on at least two side surfaces of the display panel PN.

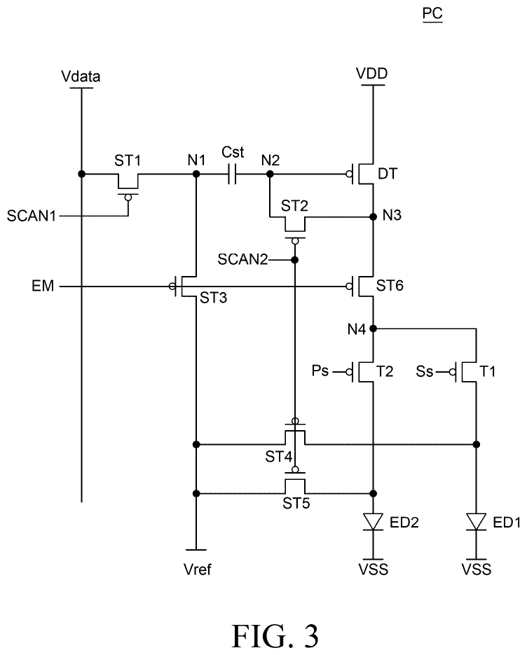

FIG. 3 is a circuit diagram illustrating an example of a pixel circuit included in a display device according to an example embodiment of the present disclosure.

In the meantime, the pixel circuit PC illustrated in FIG. 3 indicates an example embodiment of a pixel circuit corresponding to each of the plurality of pixels PX included in the display device 100 which has been described with reference to FIG. 2.

Referring to FIG. 3, at least some of the plurality of transistors included in the pixel circuit PC may be an n-type transistor or a p-type transistor. In the case of the p-type transistor, a low level voltage of each driving signal may refer to a voltage which turns on a TFT and a high level voltage of each driving signal may refer to a voltage which turns off the TFT.

Here, the low level voltage may correspond to a predetermined voltage which is lower than the high level. For example, the low level voltage may include a voltage corresponding to a range of −8 V to −12 V. The high level voltage may correspond to a predetermined voltage which is higher than the low level voltage. For example, the high level voltage may include a voltage corresponding to the range of 12 V to 16 V. According to the example embodiment, the low level voltage may be referred to as a first voltage and the high level voltage may be referred to as a second voltage. In this case, the first voltage may be lower than the second voltage.

The pixel circuit PC may include a driving transistor DT, a plurality of switching transistors ST1 to ST6, a first transistor T1, a second transistor T2, a storage capacitor Cst, and a plurality of light emitting diodes ED1 and ED2.

The driving transistor DT may control a driving current applied to the plurality of light emitting diodes ED1 and ED2 in accordance with a source-gate voltage. The driving transistor DT may include a source electrode connected to a high potential power line which supplies a high potential power voltage VDD, a gate electrode connected to a second node N2, and a drain electrode connected to a third node N3.

A first switching transistor ST1 may apply a data voltage Vdata from the data line DL to a first node N1. The first switching transistor ST1 may include a source electrode connected to the data line DL, a drain electrode connected to the first node N1, and a gate electrode connected to a first scan signal line to which a first scan signal SCAN1 is applied. The first switching transistor ST1 may be turned on or turned off by the first scan signal SCAN1. Accordingly, the first switching transistor ST1 may apply a data voltage Vdata from the data line DL to the first node N1, in response to a low level of first scan signal SCAN1 which is a turn-on level.

A second switching transistor ST2 may diode-connect the gate electrode and the drain electrode of the driving transistor DT. The second switching transistor ST2 may include a drain electrode connected to a second node N2, a source electrode connected to a third node N3, and a gate electrode connected to a second scan signal line to which a second scan signal SCAN2 is applied. The second switching transistor ST2 may be turned on or turned off by the second scan signal SCAN2. Therefore, the second switching transistor ST2 may diode-connect the gate electrode and the drain electrode of the driving transistor DT in response to a low level of second scan signal SCAN2 which is a turn-on level.

A third switching transistor ST3 may apply a reference voltage Vref to the first node N1. The third switching transistor ST3 may include a source electrode which is connected to the reference voltage line which supplies the reference voltage Vref, a drain electrode which is connected to the first node N1, and a gate electrode which is connected to the emission signal line to which the emission signal EM is applied. The third switching transistor ST3 may be turned on or turned off by the emission signal EM. Accordingly, the third switching transistor ST3 may transmit the reference voltage Vref to the first node N1 in response to a low level of emission signal EM which is a turn-on level.

A fourth switching transistor ST4 may apply the reference voltage Vref to the anode electrode of the first light emitting diode ED1. The fourth transistor T4 may include a source electrode connected to the reference voltage line which supplies the reference voltage Vref, a drain electrode connected to the anode electrode of the first light emitting diode ED1, and a gate electrode connected to a second scan signal line to which a second scan signal SCAN2 is applied. The fourth switching transistor ST4 may be turned on or turned off by the second scan signal SCAN2. Therefore, the fourth switching transistor ST4 may apply the reference voltage Vref to the anode electrode of the first light emitting diode ED1 in response to the low level of second scan signal SCAN2 which is a turn-on level.

A fifth switching transistor ST5 may apply the reference voltage Vref to the anode electrode of the second light emitting diode ED2. The fifth switching transistor ST5 may include a source electrode connected to the reference voltage line which supplies the reference voltage Vref, a drain electrode connected to the anode electrode of the second light emitting diode ED2, and a gate electrode connected to a second scan signal line to which a second scan signal SCAN2 is applied. The fifth switching transistor ST5 may be turned on or turned off by the second scan signal SCAN2. Therefore, the fifth switching transistor ST5 may apply the reference voltage Vref to the anode electrode of the second light emitting diode ED2 in response to the low level of second scan signal SCAN2 which is a turn-on level.

A sixth switching transistor ST6 may form a current path between the driving transistor DT and any one light emitting diode among the plurality of light emitting diodes ED1 and ED2. The sixth switching transistor ST6 may include a source electrode connected to the third node N3, a drain electrode connected to the fourth node N4, and a gate electrode connected to the emission signal line to which an emission signal EM is applied. The sixth switching transistor ST6 may be turned on or turned off by the emission signal EM. Therefore, the sixth switching transistor ST6 electrically connects the third node N3 and the fourth node N4 in response to a low level of emission signal EM which is a turn-on level to form a current path between the driving transistor DT and any one light emitting diode among the plurality of light emitting diodes ED1 and ED2.

A storage capacitor Cst may include a first electrode connected to the first node N1 and a second electrode connected to the second node N2. One electrode of the storage capacitor Cst may be connected to the gate electrode of the driving transistor DT and the other electrode of the storage capacitor Cst may be connected to the first switching transistor ST1. The storage capacitor Cst stores a predetermined voltage to constantly maintain a voltage of the gate electrode of the driving transistor DT while any one of the plurality of light emitting diodes ED1 and ED2 emits light.

A first transistor T1 may generate a current path of a first driving current which passes through the first light emitting diode ED1 and the second transistor T2 may generate a current path of a second driving current which passes through the second light emitting diode ED2.

The first transistor T1 may be connected between the fourth node N4 and the first light emitting diode ED1 and a gate electrode of the first transistor T1 may be connected to a first mode signal line which supplies a first mode signal Ss. When the pixel PX to which the pixel circuit PC is applied is driven in a first mode which is a wide field-of-view mode, the first mode signal Ss is supplied to the gate electrode of the first transistor T1 to turn on the first transistor T1. Therefore, a current path of the first driving current which passes through the first light emitting diode ED1 is formed so that the first light emitting diode ED1 may emit light. In the meantime, the first transistor T1 may be referred to as a first emission control transistor which controls emission of the first light emitting diode ED1.

A second transistor T2 may be connected between the fourth node N4 and the second light emitting diode ED2 and a gate electrode of the second transistor T2 may be connected to a second mode signal line which supplies a second mode signal Ps. When the pixel PX to which the pixel circuit PC is applied is driven in a second mode which is a narrow field-of-view mode, the second mode signal Ps is supplied to the gate electrode of the second transistor T2 to turn on the second transistor T2. Therefore, a current path of the second driving current which passes through the second light emitting diode ED2 is formed so that the second light emitting diode ED2 may emit light. In the meantime, the second transistor T2 may be referred to as a second emission control transistor which controls emission of the second light emitting diode ED2.

A first light emitting diode ED1 may be connected between the first transistor T1 which is turned on or turned off by the first mode signal Ss and the low potential power line which supplies a low potential power voltage VSS. A second light emitting diode ED2 may be connected between the second transistor T2 which is turned on or turned off by the second mode signal Ps and the low potential power line which supplies a low potential power voltage VSS.

In this case, the first light emitting diode ED1 or the second light emitting diode ED2 may be connected to another configuration of the pixel circuit PC, for example, the driving transistor DT, by the first transistor T1 or the second transistor T2 which is turned on according to a driving mode. For example, the first light emitting diode ED1 is connected to the driving transistor DT via the first transistor T1 which is turned on in the first mode and may supply light by the first driving current, in the first mode, that is, in the wide field-of-view mode at a wide viewing angle which is a first viewing angle. Further, the second light emitting diode ED2 is connected to the driving transistor DT via the second transistor T2 which is turned on in the second mode and may supply light by the second driving current, at a narrow viewing angle which is a second viewing angle, in the second mode, that is, in the narrow field-of-view mode. Here, the driving mode may be specified by the user's input or determined when a predetermined condition is satisfied.

In the first mode, only the first light emitting diode ED1 may emit light and in the second mode, only the second light emitting diode ED2 may emit light. Here, the second mode signal Ps which controls the emission of the second light emitting diode ED2 to allow only the first light emitting diode ED1 to emit light in the first mode may be output only at a high level which is a turn-off level. Further, the first mode signal Ss which controls the emission of the first light emitting diode ED1 to allow only the second light emitting diode ED2 to emit light in the second mode may be output only at a high level which is a turn-off level.

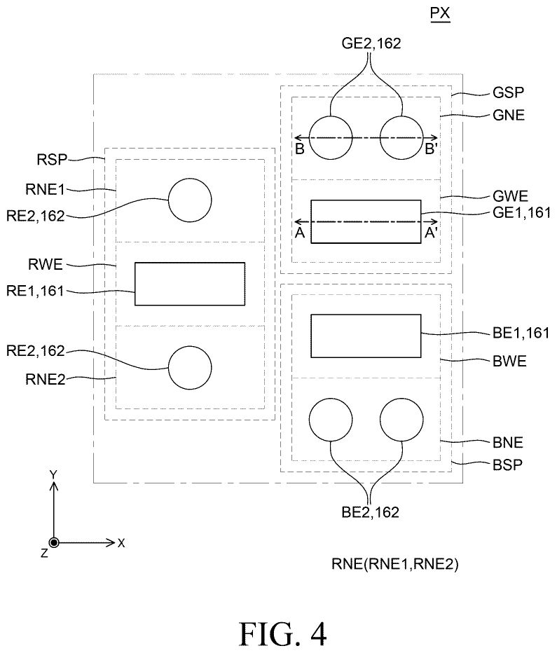

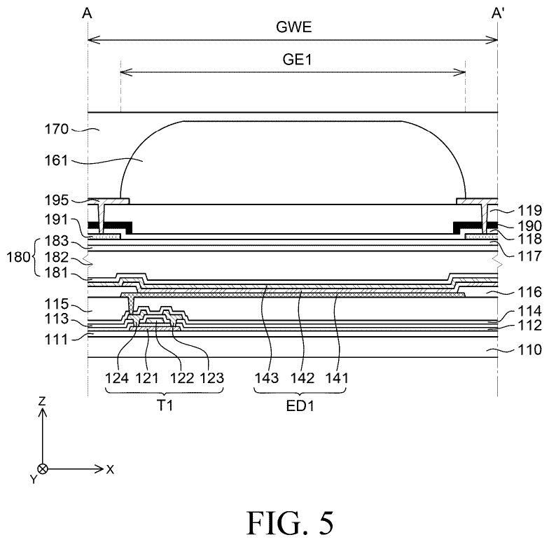

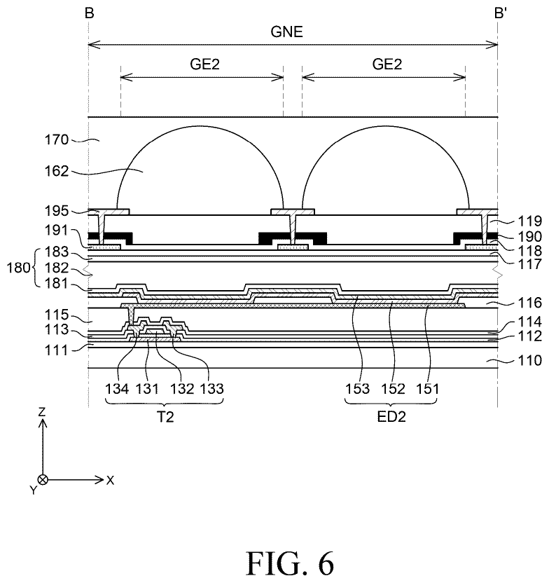

FIG. 4 is an enlarged plan view illustrating placement of an optical member included in a display device according to an example embodiment of the present disclosure. FIG. 5 is a cross-sectional view illustrating an example taken along the line A-A′ of FIG. 4. FIG. 6 is a cross-sectional view illustrating an example taken along the line B-B′ of FIG. 4.

In the meantime, FIG. 4 illustrates a plane of a pixel PX when the pixel PX includes three sub pixels, for example, a first sub pixel RSP, a second sub pixel GSP, and a third sub pixel BSP.

Further, FIG. 5 illustrates a pixel in which a first optical member 161 is disposed as an example embodiment of a display device 100 taken along the line A-A′ of FIG. 4 and FIG. 6 illustrates a pixel in which a second optical member 162 is disposed as an example embodiment of a display device 100 taken along the line B-B′ of FIG. 4.

In the meantime, in FIGS. 5 and 6, for the convenience of description, only a region corresponding to a first optical area GWE and a second optical area GNE of the second sub pixel GSP, among three sub pixels RSP, GSP, and BSP illustrated in FIG. 4, is illustrated. However, the other sub pixels RSP and BSP may also be formed with the same configuration.

In the meantime, for the convenience of description, hereinafter, a horizontal direction on the plain is illustrated as a first direction X and a vertical direction on the plane is illustrated as a second direction Y. Further, a normal direction of a plane defined by the first direction X and the second direction Y, for example, a thickness direction of the display device 100 may be defined as a third direction Z.

Referring to FIG. 4, the pixel PX may include a plurality of sub pixels RSP, GSP, and BSP which represents different colors. For example, the pixel PX may include a first sub pixel RSP which implements red, a second sub pixel GSP which implements green, and a blue sub pixel BSP which implements blue. According to the example embodiment, a first sub pixel RSP may be referred to as a red sub pixel, a second sub pixel GSP may be referred to as a green sub pixel, and a third sub pixel BSP may be referred to as a blue sub pixel. In each of the plurality of sub pixels RSP, GSP, and BSP included in the pixel PX, the pixel circuit PC which has been described with reference to FIG. 3 may be disposed.

The plurality of sub pixels RSP, GSP, and BSP may include first optical areas RWE, GWE, and BWE and second optical areas RNE, GNE, and BNE which provide different viewing angles, respectively.

The first optical areas RWE, GWE, and BWE of the sub pixels RSP, GSP, and BSP may operate independently from the second optical areas RNE, GNE, and BNE of the corresponding pixels PX. For example, each sub pixel RSP, GSP, or BSP may include a first light emitting diode ED1 disposed in the first optical area RWE, GWE, or BWE of a corresponding sub pixel RSP, GSP, or BSP and a second light emitting diode ED2 disposed in the second optical area RNE, GNE, or BNE of a corresponding sub pixel RSP, GSP, or BSP.

At least some of the plurality of sub pixels RSP, GSP, and BSP may include a plurality of second optical areas RNE, GNE, and BNE. For example, the first sub pixel RSP may include one first optical area RWE and a plurality of second optical areas RNE1 and RNE2. For example, the first optical area RWE may be disposed between the plurality of second optical areas RNE1 and RNE2. For example, in the second direction Y, one second optical area RNE1, a first optical area RWE, and the other second optical area RNE2 may be sequentially disposed, but the present disclosure is not limited thereto.

In one pixel PX, the first light emitting diode ED1 and the second light emitting diode ED2 may be disposed in every first optical area RWE, GWE, or BWE and every second optical areas RNE, GNE, or BNE of the plurality of sub pixels RSP, GSP, and BSP, respectively.

For example, in one pixel PX, a first light emitting diode ED1 disposed in the first optical area RWE of the first sub pixel RSP, a second light emitting diode ED2 disposed in the second optical area RNE of the first sub pixel RSP, a first light emitting diode ED1 disposed in the first optical area GWE of the second sub pixel GSP, a second light emitting diode ED2 disposed in the second optical area GNE of the second sub pixel GSP, a first light emitting diode ED1 disposed in the first optical area BWE of the third sub pixel BSP, and a second light emitting diode ED2 disposed in the second optical area BNE of the third sub pixel BSP may be disposed.

Referring to FIG. 4, in the first optical area RWE, GWE, or BWE of each sub pixel RSP, GSP, or BSP, at least one first optical member 161 disposed so as to overlap the first emission area RE1, GE1, or BE1 of the first light emitting diode ED1 may be disposed. In the second optical area RNE, GNE, or BNE of each sub pixel RSP, GSP, or BSP, at least one second optical member 162 disposed so as to overlap the second emission area RE2, GE2, or BE2 of the second light emitting diode ED2 may be disposed. At this time, the first optical areas RWE, GWE, and BWE may have a first viewing angle and the second optical areas RNE, GNE, and BNE may have a second viewing angle which is smaller than the first viewing angle.

In the meantime, in each sub pixel RSP, GSP, or BSP, the first light emitting diode ED1 and the second light emitting diode ED2 may be disposed in different manners. For example, in the first sub pixel RSP, one second light emitting diode ED2, the first light emitting diode ED1, and the other second light emitting diode ED2 may be sequentially disposed in the second direction Y. In contrast, in the second sub pixel GSP, the plurality of second light emitting diodes ED2 may be disposed in the second optical area GNE and one first light emitting diode ED1 may be disposed in the first optical area GWE. At this time, the plurality of second light emitting diodes ED2 may be disposed on the same line in the first direction X. The first light emitting diode ED1 and the plurality of second light emitting diodes ED2 may be disposed so as to overlap each other in the second direction Y. Further, in the second sub pixel GSP, the plurality of second light emitting diodes ED2 may be disposed above the first light emitting diode ED1. Next, in the third sub pixel BSP, the plurality of second light emitting diodes ED2 may be disposed in the second optical area BNE and one first light emitting diode ED1 may be disposed in the first optical area BWE. At this time, the plurality of second light emitting diodes ED2 may be disposed on the same line in the first direction X. The first light emitting diode ED1 and the plurality of second light emitting diodes ED2 may be disposed so as to overlap each other in the second direction Y. Further, in the third sub pixel BSP, the plurality of second light emitting diodes ED2 may be disposed below the first light emitting diode ED1. However, this is just an example so that the placement of the first light emitting diode ED1 and the second light emitting diode ED2 in each sub pixel RSP, GSP, or BSP is not limited thereto.

Referring to FIGS. 5 and 6 together, the display device 100 according to the example embodiment of the present disclosure may include a substrate 110, a buffer film 111, a gate insulating film 112, a first interlayer insulating film 113, a lower protection film 114, an overcoat layer 115, a bank 116, a first transistor T1, a second transistor T2, a first light emitting diode ED1, a second light emitting diode ED2, an encapsulation member 180, a touch buffer layer 117, a second interlayer insulating film 118, a third interlayer insulating film 119, a black matrix 190, a touch bridge electrode 191, a touch electrode 195, a first optical member 161, a second optical member 162, and an optical member protection film 170.

The substrate 110 may include an insulating material. The substrate 110 may include a transparent material. For example, the substrate 110 may include glass or plastic.

The buffer film 111 may be disposed on the substrate 110. The buffer film 111 may include an insulating material. For example, the buffer film 111 may include an inorganic insulating material, such as silicon oxide (SiOx) or silicon nitride (SiNx). The buffer film 111 may have a multilayered structure. For example, the buffer film 111 may have a laminated structure of a film formed of silicon nitride (SiNx) and a film formed of silicon oxide (SiOx).

The buffer film 111 may be located between the substrate 110 and a driving part of each sub pixel RSP, GSP, or BSP. The buffer film 111 may suppress the contamination due to the substrate 110 in a process of forming the driving part. For example, a top surface of the substrate 110 which faces the driving part of each sub pixel RSP, GSP, or BSP may be covered by the buffer film 111. The driving part of each sub pixel RSP, GSP, or BSP may be disposed on the buffer film 111.

The gate insulating film 112 may be disposed on the buffer film 111. The gate insulating film 112 may include an insulating material. For example, the gate insulating film 112 may include an inorganic insulating material, such as silicon oxide (SiO) or silicon nitride (SiN). The gate insulating film 112 may include a material having a high permittivity. For example, the gate insulating film 112 may include a High-K material, such as hafnium oxide (HfO). The gate insulating film 112 may have a multilayered structure.

The first interlayer insulating film 113 may be disposed on the gate insulating film 112. The first interlayer insulating film 113 may include an insulating material. For example, the first interlayer insulating film 113 may include an inorganic insulating material, such as silicon oxide (SiO) or silicon nitride (SiN). The first interlayer insulating film 113 may extend between the gate electrodes 122 and 132 and the source electrodes 123 and 133 of the first transistor T1 and the second transistor T2 and between the gate electrodes 122 and 132 and the drain electrodes 124 and 134. For example, the source electrodes 123 and 133 and the drain electrodes 124 and 134 of the first transistor T1 and the second transistor T2 may be insulated from the gate electrodes 122 and 132 by the first interlayer insulating film 113. The first interlayer insulating film 113 may cover the gate electrodes 122 and 132 of the first transistor T1 and the second transistor T2. The source electrodes 123 and 133 and the drain electrodes 124 and 134 of each sub pixel RSP, GSP, or BSP may be located on the first interlayer insulating film 113. The gate insulating film 112 and the first interlayer insulating film 113 may expose a source region and a drain region of each semiconductor layer 121, or 131 located in each sub pixel RSP, GSP, or BSP.

The lower protection film 114 may be disposed on the first interlayer insulating film 113. The lower protection film 114 may include an insulating material. For example, the lower protection film 114 may include an inorganic insulating material, such as silicon oxide (SiO) or silicon nitride (SiN).

The lower protection film 114 may suppress the damage of the driving part due to the external moisture and shocks. The lower protection film 114 may extend along surfaces of the first transistor T1 and the second transistor T2. The lower protection film 114 may be in contact with the first interlayer insulating film 113 at the outside of the driving part located in each sub pixel RSP, GSP, or BSP.

The overcoat layer 115 may be disposed on the lower protection film 114. The overcoat layer 115 may include an insulating material. The overcoat layer 115 may include a material different from that of the lower protection film 114. For example, the overcoat layer 115 may include an organic insulating material.

The overcoat layer 115 may remove a step caused by the driving part of each sub pixel RSP, GSP, or BSP. For example, a top surface of the overcoat layer 115 which is opposite to the substrate 110 may be a flat surface.

The first transistor T1 and the second transistor T2 may be disposed on the substrate 110. The first transistor T1 may be electrically connected between the drain electrode of the driving transistor DT and the first lower electrode 141 of the first light emitting diode ED1. The second transistor T2 may be electrically connected between the drain electrode of the driving transistor DT and the second lower electrode 151 of the second light emitting diode ED2.

The first transistor T1 may include a first semiconductor layer 121, a first gate electrode 122, a first source electrode 123, and a first drain electrode 124. The first transistor T1 may have the same structure as the switching transistor and the driving transistor.

For example, the first semiconductor layer 121 may be located between the buffer film 111 and the gate insulating film 112 and the first gate electrode 122 may be located between the gate insulating film 112 and the first interlayer insulating film 113. The first source electrode 123 and the first drain electrode 124 may be located between the first interlayer insulating film 113 and the lower protection film 114. The first gate electrode 122 may overlap a channel region of the first semiconductor layer 121. The first source electrode 123 may be electrically connected to the source region of the first semiconductor layer 121. The first drain electrode 124 may be electrically connected to the drain region of the first semiconductor layer 121.

The second transistor T2 may include a second semiconductor layer 131, a second gate electrode 132, a second source electrode 133, and a second drain electrode 134. For example, the second semiconductor layer 131 may be located on the same layer as the first semiconductor layer 121 and the second gate electrode 132 may be located on the same layer as the first gate electrode 122. The second source electrode 133 and the second drain electrode 134 may be located on the same layer as the first source electrode 123 and the first drain electrode 124.

The first light emitting diode ED1 and the second light emitting diode ED2 of each sub pixel RSP, GSP, or BSP may be located on the overcoat layer 115 of a corresponding sub pixel RSP, GSP, or BSP. For example, the first lower electrode 141 of the first light emitting diode ED1 may be electrically connected to the first drain electrode 124 or the first source electrode 123 of the first transistor T1 through a contact hole which passes through the lower protection film 114 and the overcoat layer 115. A second lower electrode 151 of the second light emitting diode ED2 may be electrically connected to the second drain electrode 134 or the second source electrode 133 of the second transistor T2 through a contact hole which passes through the lower protection film 114 and the overcoat layer 115.

The first light emitting diode ED1 may emit light representing a specific color. For example, the first light emitting diode ED1 may include a first lower electrode 141, a first emission layer 142, and a first upper electrode 143 which are sequentially laminated on the substrate 110.

The first lower electrode 141 may include a conductive material. The first lower electrode 141 may include a material having a high reflectance. For example, the first lower electrode 141 may include metal, such as aluminum (Al), and silver (Ag). The first lower electrode 141 may have a multi-layered structure. For example, the first lower electrode 141 may have a structure in which a reflective electrode formed of a metal is located between transparent electrodes formed of a transparent conductive material, such as ITO and IZO. The first lower electrode 141 may be electrically connected to the first drain electrode 124 of the first transistor T1 through a contact hole which passes through the lower protection film 114 and the overcoat layer 115.

The first emission layer 142 may generate light with luminance corresponding to a voltage difference between the first lower electrode 141 and the first upper electrode 143. For example, the first emission layer 142 may include an emission material layer (EML) including an emission material. The emission material may include an organic material, an inorganic material, or a hybrid material.

The first emission layer 142 may have a multi-layered structure. For example, the first emission layer 142 may further include at least one of a hole injection layer HIL, a hole transport layer HTL, an electron transport layer ETL, and an electron injection layer EIL.

The first upper electrode 143 may include a conductive material. The first upper electrode 143 may include a different material from that of the first lower electrode 141. A transmittance of the first upper electrode 143 may be higher than a transmittance of the first lower electrode 141. For example, the first upper electrode 143 may be a transparent electrode formed of a transparent conductive material, such as ITO and IZO. Accordingly, in the display device 100 according to the example embodiment of the present disclosure, light generated by the first emission layer 142 may be emitted through the first upper electrode 143.

The second light emitting diode ED2 may implement the same color as the first light emitting diode ED1 disposed in the same sub pixel RSP, GSP, or BSP. For example, the second light emitting diode ED2 may include a second lower electrode 151, a second emission layer 152, and a second upper electrode 153 which are sequentially laminated on the substrate 110.

The second lower electrode 151 may correspond to the first lower electrode 141, the second emission layer 152 may correspond to the first emission layer 142, and the second upper electrode 153 may correspond to the first upper electrode 143. For example, the second lower electrode 151 may be formed for the second light emitting diode ED2 with the same structure as the first lower electrode 141 and this is the same for the second emission layer 152 and the second upper electrode 153. For example, the first light emitting diode ED1 and the second light emitting diode ED2 may be formed to have the same structure. However, it is not limited thereto and, in some cases, at least a partial configuration of the first light emitting diode ED1 and the second light emitting diode ED2 may be formed to be different.

The second emission layer 152 may be spaced apart from the first emission layer 142. Therefore, in the display device according to the example embodiment of the present disclosure, light emission by a leakage current may be suppressed.

According to the example embodiment of the present disclosure, in the display device, light may be generated by only one of the first emission layer 142 and the second emission layer 152 by the user's choice or according to a predetermined condition.

The second lower electrode 151 of each sub pixel RSP, GSP, or BSP may be spaced apart from the first lower electrode 141 of the corresponding sub pixel RSP, GSP, or BSP. For example, the bank 116 may be disposed between the first lower electrode 141 and the second lower electrode 151 of each sub pixel RSP, GSP, or BSP. The bank 116 may include an insulating material. For example, the bank 116 may include an organic insulating material. The bank 116 may include a material different from that of the overcoat layer 115.

The second lower electrode 151 of each sub pixel RSP, GSP, or BSP may be insulated from the first lower electrode 141 of the corresponding sub pixel RSP, GSP, or BSP by the bank 116. For example, the bank 116 may cover an edge of the first lower electrode 141 and an edge of the second lower electrode 151 located in each sub pixel RSP, GSP, or BSP.

The bank 116 may divide the first emission areas RE1, GE1, and BE1 of the first light emitting diode ED1 and the second emission areas RE2, GE2, and BE2 of the second light emitting diode ED2. For example, the first emission areas RE1, GE1, and BE1 of the first light emitting diode ED1 may be a partial area of the first lower electrode 141 which is exposed by the bank 116. The second emission areas RE2, GE2, and BE2 of the second light emitting diode ED2 may be a partial area of the second lower electrode 151 which is exposed by the bank 116. At this time, referring to FIG. 5, a size of the first emission areas RE1, GE1, and BE1 of the first light emitting diode ED1 divided in each sub pixel RSP, GSP, or BSP may be larger than a size of the second emission areas RE2, GE2, and BE2 of the second light emitting diode ED2, but is not limited thereto.

The first emission layer 142 and the first upper electrode 143 of the first light emitting diode ED1 located in each sub pixel RSP, GSP, or BSP may be laminated on a partial area of the first lower electrode 141 exposed by the bank 116. Specifically, the first emission layer 142 and the first upper electrode 143 may be laminated on the first emission areas RE1, GE1, and BE1 exposed by the bank 116 and the bank 116. The second emission layer 152 and the second upper electrode 153 of the second light emitting diode ED2 located in each sub pixel RSP, GSP, or BSP may be laminated on a partial area of the second lower electrode 151 exposed by the bank 116. Specifically, the second emission layer 152 and the second upper electrode 153 may be laminated on the second emission areas RE2, GE2, and BE2 exposed by the bank 116 and the bank 116.

The second upper electrode 153 of each sub pixel RSP, GSP, or BSP may be electrically connected to the first upper electrode 143 of the corresponding sub pixel RSP, GSP, or BSP. For example, a voltage applied to the second upper electrode 153 of the second light emitting diode ED2 located in each sub pixel RSP, GSP, or BSP may be equal to a voltage applied to the first upper electrode 143 of the first light emitting diode ED1 located in the corresponding sub pixel RSP, GSP, or BSP. The second upper electrode 153 of each sub pixel RSP, GSP, or BSP may include the same material as the first upper electrode 143 of the corresponding sub pixel RSP, GSP, or BSP. For example, the second upper electrode 153 of each sub pixel RSP, GSP, or BSP may be formed simultaneously with the first upper electrode 143 of the corresponding sub pixel RSP, GSP, or BSP. The second upper electrode 153 of each sub pixel RSP, GSP, or BSP extends onto the bank 116 to be in direct contact with the first upper electrode 143 of the corresponding sub pixel RSP, GSP, or BSP. Luminance of the first optical areas RWE, GWE, and BWE and luminance of the second optical areas RNE, GNE, and BNE located in each sub pixel RSP, GSP, or BSP may be controlled by a driving current generated in the corresponding sub pixel RSP, GSP, or BSP.

The encapsulation member 180 may be located on the first light emitting diode ED1 and the second light emitting diode ED2 of each sub pixel RSP, GSP, or BSP. The encapsulation member 180 may suppress the damage of the light emitting diodes ED1 and ED2 due to moisture and shocks from the outside. The encapsulation member 180 may have a multi-layered structure. For example, the encapsulation member 180 may include a first encapsulation layer 181, a second encapsulation layer 182, and a third encapsulation layer 183 which are sequentially laminated, but the example embodiments of the present disclosure are not limited thereto.

The first encapsulation layer 181, the second encapsulation layer 182, and the third encapsulation layer 183 may include an insulating material. The second encapsulation layer 182 may include a material different from those of the first encapsulation layer 181 and the third encapsulation layer 183. For example, the first encapsulation layer 181 and the third encapsulation layer 183 are inorganic encapsulation layers including an inorganic insulating material and the second encapsulation layer 182 may include an organic encapsulation layer including an organic insulating material. Therefore, the light emitting diodes ED1 and ED2 of the display device 100 may efficiently suppress the damage due to the moisture and shocks from the outside.

A touch buffer layer 117 may be disposed on the encapsulation member 180. The touch buffer layer 117 is disposed between the encapsulation member 180 and the touch bridge electrode 191 to insulate the touch bridge electrode 191. For example, the touch buffer layer 117 may include an insulating material. For example, the touch buffer layer 117 may be formed of an organic insulating material or an inorganic insulating material, but is not limited thereto.

The touch bridge electrode 191 may be disposed on the touch buffer layer 117. The touch bridge electrode 191 may be electrically connected to the touch electrodes 195 on the second interlayer insulating film 118. For example, the touch bridge electrode 191 may include a metal material, such as titanium (Ti), aluminum (Al), silver (Ag), copper (Cu), and a magnesium-silver alloy (Mg:Ag), but is not limited thereto.

The second interlayer insulating film 118 may be disposed on the touch bridge electrode 191. The second interlayer insulating film 118 is disposed between the touch bridge electrode 191 and the black matrix 190 to insulate the touch bridge electrode 191. The second interlayer insulating film 118 may include an insulating material. For example, the second interlayer insulating film 118 may include an organic insulating material or an inorganic insulating material, but is not limited thereto.

The black matrix 190 may be disposed on the second interlayer insulating film 118. The black matrix 190 may be disposed between the plurality of sub pixels RSP, GSP, and BSP so as to reduce color mixture of the plurality of sub pixels RSP, GSP, and BSP. Therefore, the black matrix 190 may be disposed so as to overlap the bank 116.

The third interlayer insulating film 119 may be disposed on the black matrix 190. The third interlayer insulating film 119 may include an insulating material. For example, the second interlayer insulating film 118 may include an organic insulating material or an inorganic insulating material, but is not limited thereto.

A plurality of touch electrodes 195 may be disposed on the third interlayer insulating film 119. The plurality of touch electrodes 195 may be disposed above the first light emitting diode ED1 and the second light emitting diode ED2 in the active area. The plurality of touch electrodes 195 may be disposed so as to be spaced apart from each other on the third interlayer insulating film 119.

The plurality of touch electrodes 195 may be configured to sense external touch input using a user's finger or a touch pen. For example, the touch electrodes 195 may include a metal material, such as titanium (Ti), aluminum (Al), silver (Ag), copper (Cu), and a magnesium-silver alloy (Mg:Ag), but are not limited thereto.

The plurality of touch electrodes 195 may be disposed so as to overlap the bank 116 and the black matrix 190. If the plurality of touch electrodes 195 includes an opaque metal material, the plurality of touch electrodes 195 may also serve as a barrier layer which limits a path of light generated by the first light emitting diode ED1 and the second light emitting diode ED2. For example, the plurality of touch electrodes 195 may block light which travels to the lateral direction, among light emitted from the first emission areas RE1, GE1, and BE1 and the second emission areas RE2, GE2, and BE2. That is, the plurality of touch electrodes 195 may block light which travels to the lateral direction, among light emitted from the first emission areas RE1, GE1, and BE1 and the second emission areas RE2, GE2, and BE2 located in each sub pixel RSP, GSP, or BSP, together with the first optical member 161 and the second optical member 162.

The first optical member 161 and the second optical member 162 are disposed on the third interlayer insulating film 119.

The first optical member 161 and the second optical member 162 may be disposed on the same layer as the plurality of touch electrodes 195 on the third interlayer insulating film 119. For example, the first optical member 161 and the second optical member 162 may be disposed so as to cover edges of the plurality of touch electrodes 195, respectively. Therefore, an end of each of the first optical member 161 and the second optical member 162 may be disposed on the plurality of touch electrodes 195.

At this time, a center of the first optical member 161 may match a center of the first emission area RE1, GE1, or BE1. Further, a center of the second optical member 162 may match a center of the second emission area RE2, GE2, or BE2, but is not limited thereto.

First, referring to FIG. 5, the first optical member 161 is disposed on the first light emitting diode ED1. Light generated by the first light emitting diode ED1 of each sub pixel RSP, GSP, or BSP may be emitted through the first optical member 161 disposed in the first optical area RWE, GWE, or BWE of the corresponding sub pixel RSP, GSP, or BSP.

The first optical member 161 has a shape which does not restrict the light from traveling in at least one direction. In the present disclosure, a planar shape of the first optical member 161 located in each sub pixel RSP, GSP, or BSP may have a shape which extends in the first direction X. For example, a planar shape of the first optical member 161 may have a bar shape extending in the first direction X. Therefore, the planar shape of the first optical member 161 may include a long side extending in the first direction X and a short side which is connected from both ends of the long side to the second direction Y. For example, a planar shape of the first optical member 161 may be a rectangle with a long side placed in the first direction X.

In this case, a traveling direction of light emitted from the first optical area RWE, GWE, or BWE of each sub pixel RSP, GSP, or BSP may not be limited in the first direction X. For example, contents (or images) provided through the first optical area RWE, GWE, or BWE of each sub pixel RSP, GSP, or BSP may be shared by surrounding people which is adjacent to the user in the first direction X. Accordingly, the contents provided by the light emitted through the first optical member 161 may be provided at a viewing angle which is larger in the first direction X than contents provided by the light emitted through the second optical member 162. For example, the content provided by the light emitted through the first optical member 161 may be provided in a wide field-of-view mode (share mode).

At least a part of a top surface of a cross-sectional shape of the first optical member 161 taken along the first direction X may be flat. Further, both side surfaces of the first optical member 161 may be formed as a curved line or a straight line. For example, referring to FIG. 5, a cross-sectional shape with respect to the long side of the first optical member 161 may be formed by an upper flat surface and a curved line which is connected from both ends of the flat surface to the third interlayer insulating film 119. Alternatively, for example, a cross-sectional shape with respect to the long side of the first optical member 161 may be formed by an upper flat surface and a straight line which is vertically connected from both ends of the flat surface toward the third interlayer insulating film 119.

Next, referring to FIG. 6, the second optical member 162 is disposed on the second light emitting diode ED2. Light generated by the second light emitting diode ED2 of each sub pixel RSP, GSP, or BSP is refracted through the second optical member 162 disposed in the second optical area RNE, GNE, or BNE of a corresponding sub pixel RSP, GPS, or BSP to be emitted. The second optical member 162 may limit the traveling of the passing light in the first direction X. For example, a planar shape of the second optical member 162 located in each sub pixel RSP, GSP, or BSP may be a circular shape. However, it is not limited thereto and a planar shape of the second optical member 162 located in each sub pixel RSP, GSP, or BSP may have a polygonal shape.

In this case, traveling of light emitted from the second optical area RNE, GNE, or BNE of each sub pixel RSP, GSP, or BSP in the first direction X may be limited. For example, the contents (or images) provided by the second optical areas RNE, GNE, and BNE of each sub pixel RSP, GSP, or BSP may not be shared by the people around the user. Accordingly, the contents provided by the light emitted through the second optical member 162 may be provided at a viewing angle which is smaller in the left and right than the contents provided by the light emitted through the first optical member 161. For example, the contents provided by the light emitted through the second optical member 162 may be provided in a narrow field-of-view mode (private mode).

A cross-sectional shape of the second optical member 162 taken along the first direction X may be a semicircular shape, but is not limited thereto. The first emission area RE1, GE1, and BE1 of each pixel PX may have a shape corresponding to the first optical member 161 of the corresponding sub pixel RSP, GSP, or BSP. For example, a planar shape of the first emission area RE1, GE1, or BE1 of each sub pixel RSP, GSP, or BSP may have a bar shape which extends in the first direction X. The first optical member 161 may have a size larger than the first emission area RE1, GE1, or BE1 of the corresponding sub pixel RSP, GPS, or BSP. Accordingly, efficiency of light emitted from the first emission area RE1, GE1, or BE1 of each sub pixel RSP, GSP, or BSP may be improved.

The second emission area RE2, GE2, or BE2 of each sub pixel RSP, GSP, or BSP may have a shape corresponding to the second optical member 162 of the corresponding sub pixel RSP, GSP, or BSP. For example, a planar shape of the second emission area RE2, GE2, or BE2 of each sub pixel RSP, GSP, or BSP may be a circular shape or a polygonal shape. The second optical member 162 may have a size larger than the second emission area RE2, GE2, or BE2 of the corresponding sub pixel RSP, GPS, or BSP. Accordingly, efficiency of light emitted from the second emission area RE2, GE2, or BE2 of each sub pixel RSP, GSP, or BSP may be improved.

In the meantime, the number of second emission areas RE2, GE2, and BE2 may vary in every second optical area RNE1, RNE2, GNE, or BNE. For example, the number of second emission areas GE2 defined in the second optical area GNE of the second sub pixel GSP and the number of second emission areas BE2 defined in the second optical area BNE of the third sub pixel BSP may be larger than the number of second emission area RE2 defined in each second optical area RNE1 or RNE2 of each first sub pixel RSP. In this case, the efficiency deviation of the second light emitting diodes ED2 located on each second optical area RNE1, RNE2, GNE, or BNE may be compensated by the number of second emission areas RE2, GE2, and BE2 defined in the second optical area RNE1, RNE2, GNE, or BNE of each sub pixel RSP, GSP, or BSP.

In the meantime, even though it is not illustrated in the drawing, an organic or inorganic insulating layer may be further disposed between the plurality of touch electrodes 195 and the optical members 161 and 162, but is not limited thereto.

The optical member protection film 170 may be located on the first optical member 161 and the second optical member 162 of each sub pixel RSP, GSP, or BSP. The optical member protection film 170 may include an insulating material. For example, the optical member protection film 170 may include an organic insulating material. A refractive index of the optical member protection film 170 may be smaller than a refractive index of the first optical member 161 and a refractive index of the second optical member 162 located in each sub pixel RSP, GSP, or BSP. Accordingly, in the display device 100 according to the example embodiment of the present disclosure, light which passes through the first optical member 161 and the second optical member 162 in each sub pixel RSP, GSP, or BSP may not be reflected toward the substrate 110 due to the refractive index difference from the optical member protection film 170.

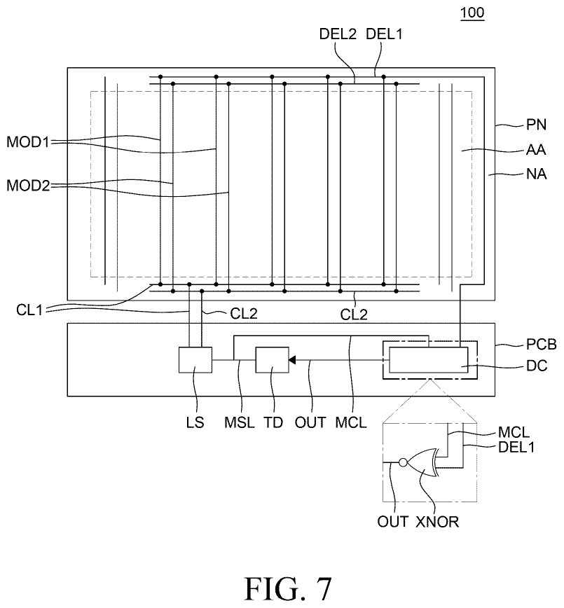

FIG. 7 is a schematic plan view of a display device according to an example embodiment of the present disclosure.

FIG. 7 is an enlarged plan view schematically illustrating a configuration of a display panel PN and a printed circuit board PCB of a display device 100 according to an example embodiment of the present disclosure.

Referring to FIG. 7, the display device 100 according to the example embodiment of the present disclosure may include a display panel PN, a printed circuit board PCB, a timing controller TD, a level shifter LS, a detection circuit DC, a first mode selection signal line MSL, a first connection line CL1, a second connection line CL2, a first mode signal line MOD1, a second mode signal line MOD2, a first detection line DEL1, a second detection line DEL2.

The display panel PN may include an active area AA and a non-active area NA.

The active area AA is an area where images are displayed in the display panel PN. Referring to FIGS. 2 and 7 together, the active area AA may include a plurality of pixels PX disposed in a row direction and a column direction. For example, the plurality of pixels PX may be disposed in an area where the plurality of data lines DL and the plurality of gate lines GL intersect.

The non-active area NA may be disposed along a periphery of the active area AA. Various components for driving the pixel circuit disposed in the pixel PX may be disposed in the non-active area NA. For example, at least a part of the gate driving circuit GD may be disposed in the non-active area NA. The non-active area NA may be referred to as a bezel area.

In the meantime, the timing controller TD, the level shifter LS, and the detection circuit DC may be disposed on the printed circuit board PCB.

The timing controller TD supplies a signal for an operation of each pixel PX. Specifically, the timing controller TD outputs a mode selection signal to drive a first mode and a second mode. The timing controller TD is connected to the level shifter LS through the mode selection signal line MSL. Therefore, the timing controller TD transmits the mode selection signal to the level shifter LS.

The level shifter LS outputs the first mode signal and the second mode signal based on the mode selection signal received from the timing controller TD. For example, the level shifter LS may output the first mode signal to the first connection line CL1 according to the mode selection signal received from the timing controller TD. Further, the level shifter LS may output the second mode signal to the second connection line CL2 according to the mode selection signal received from the timing controller TD.

The first connection line CL1 may be a wiring line which electrically connects the plurality of first mode signal lines MOD1 and the level shifter LS. Therefore, the first connection line CL1 may transmit a first mode signal output from the level shifter LS to the plurality of first mode signal lines MOD1.

The first connection line CL1 may be located in the non-active area NA of the display panel PN. For example, at least a part of the first connection line CL1 may be located in the non-active area NA located in a lower end portion of the display panel PN, but is not limited thereto. Further, the other part of the first connection line CL1 may be disposed on the printed circuit board PCB.

The second connection line CL2 may be a wiring line which electrically connects the plurality of second mode signal lines MOD2 and the level shifter LS. Therefore, the second connection line CL2 may transmit a second mode signal output from the level shifter LS to the plurality of second mode signal lines MOD2.

At least a part of the second connection line CL2 may be located in the non-active area NA. For example, at least a part of the second connection line CL2 may be located in the non-active area NA located in a lower end portion of the display panel PN, but is not limited thereto. Further, the other part of the second connection line CL2 may be disposed on the printed circuit board PCB.

The plurality of first mode signal lines MOD1 may be connected to the pixel circuit PC. For example, referring to FIG. 3, the plurality of first mode signal lines MOD1 may supply the first mode signal Ss to a first gate electrode 122 of the first transistor T1. The plurality of first mode signal lines MOD1 is connected to the first connection line CL1 to receive the first mode signal Ss output from the level shifter LS. Further, the plurality of first mode signal lines MOD1 may transmit the received first mode signal Ss to the first gate electrode 122 of the first transistor T1. Therefore, the plurality of first light emitting diodes ED1 is driven based on the first mode signal Ss.

The plurality of first mode signal lines MOD1 may be disposed in the active area AA. For example, at least a part of the plurality of first mode signal lines MOD1 may be disposed so as to overlap the active area AA. Further, the other part of the plurality of first mode signal lines MOD1 may overlap the non-active area NA. For example, the plurality of first mode signal lines MOD1 may be connected to the first connection line CL1 in the non-active area NA. Further, the plurality of first mode signal lines MOD1 may be connected to the first detection line DEL1 in the non-active area NA.

The plurality of first mode signal lines MOD1 may be disposed so as to extend in a vertical direction of the display panel PN. Further, the plurality of first mode signal lines MOD1 may be disposed to be spaced apart from each other in a horizontal direction, but is not limited thereto.

The plurality of second mode signal lines MOD2 may be connected to the pixel circuit PC. For example, referring to FIG. 3, the plurality of second mode signal lines MOD2 may transmit the second mode signal Ps to a second gate electrode 132 of the second transistor T2. The plurality of second mode signal lines MOD2 is connected to the second connection line CL2 to receive the second mode signal Ps output from the level shifter LS. Further, the plurality of second mode signal lines MOD2 may transmit the received second mode signal Ps to the second gate electrode 132 of the second transistor T2. Therefore, the plurality of second light emitting diodes ED2 is driven based on the second mode signal Ps.

The plurality of second mode signal lines MOD2 may be disposed in the active area AA. For example, at least a part of the plurality of second mode signal lines MOD2 may be disposed so as to overlap the active area AA. Further, the other part of the plurality of second mode signal lines MOD2 may overlap the non-active area NA. For example, the plurality of second mode signal lines MOD2 may be connected to the second connection line CL2 in the non-active area NA. Further, the plurality of second mode signal lines MOD2 may be connected to the second detection line DEL2 in the non-active area NA.

The plurality of second mode signal lines MOD2 may be disposed so as to extend in a vertical direction of the display panel PN. Further, the plurality of second mode signal lines MOD2 may be disposed to be spaced apart from each other in a horizontal direction, but is not limited thereto.

The display device 100 according to the example embodiment of the present disclosure may further include a plurality of additional lines, excluding the first mode signal line MOD1 and the second mode signal line MOD2. For example, the plurality of additional lines may be disposed in both side portions of the display panel PN. Further, at least a part of the plurality of additional lines may overlap the active area AA. The plurality of additional lines may be provided to operate the first mode, but is not limited thereto.

The plurality of first mode signal lines MOD1 may be connected to the first detection line DEL1. Further, the first detection line DEL1 may be connected to the detection circuit DC. Therefore, the first mode signal Ss may be transmitted to the detection circuit DC through the first detection line DEL1.

The first detection line DEL1 may be disposed in the non-active area NA. For example, the first detection line DEL1 may be connected to the plurality of first mode signal lines MOD1 in the non-active area NA located in an upper area of the display panel PN. Further, the first detection line DEL1 extends along the non-active area NA located in a side portion of the display panel PN to be connected to the detection circuit DC, but is not limited thereto.

The plurality of second mode signal lines MOD2 may be connected to the second detection line DEL2. For example, the second detection line DEL2 may be disposed in the non-active area NA. For example, the second detection line DEL2 may be connected to the plurality of second mode signal lines MOD2 in the non-active area NA located in an upper area of the display panel PN, but is not limited thereto. However, in the display device 100 according to the example embodiment of the present disclosure, the second detection line DEL2 may be omitted as needed.

The detection circuit DC receives the first mode signal Ss from the first detection line DEL1. The detection circuit DC serves to detect whether the level shifter LS and the first mode normally operate based on the received first mode signal Ss.

For example, the detection circuit DC may be electrically connected to a mode selection signal line MSL through a mode selection connection line MCL. Therefore, the detection circuit DC may receive a mode selection signal output from the timing controller TD through the mode selection connection line MCL.

As described above, the detection circuit DC receives the first mode signal Ss transmitted from the first detection line DEL1 and a mode selection signal transmitted from the mode selection connection line MCL to confirm a normal operation of the level shifter LS and the first mode. For example, the detection circuit DC may include an exclusive NOR (XNOR) gate XNOR as represented in a truth table of the following Table 1.

TABLE 1

| | Input (IN) | | Output | |
|---|---|---|---|---|
| | Mode selection signal | First mode signal | (OUT) | Result |
| 1 | 0 | 0 | 1 | Normal |
| 2 | 0 | 1 | 0 | Abnormal |
| 3 | 1 | 0 | 0 | Abnormal |
| 4 | 1 | 1 | 1 | Normal |

Referring to Table 1 together, in the display device 100 according to the example embodiment of the present disclosure, a mode selection signal which is a low level signal 0 or a high level signal 1 may be output from the timing controller TD. At this time, the low level signal 0 may be a signal for driving the first mode and the high level signal 1 may be a signal for driving the second mode, but the present disclosure is not limited thereto.

When the low level signal 0 is output from the timing controller TD, the low level signal 0 may be transmitted to the level shifter LS through the mode selection signal line MSL. Further, the low level signal 0 output from the timing controller TD may be input to the detection circuit DC through the mode selection connection line MCL.

In a normal case, if the low level signal 0 is input to the level shifter LS, the low level signal 0 may be output to the first connection line CL1 and the high level signal 1 may be output to the second connection line CL2. The low level signal 0 transmitted through the first connection line CL1 may be transmitted to the first gate electrode 122 of the first transistor T1 through the plurality of first mode signal lines MOD1. Therefore, the plurality of first light emitting diodes ED1 may be driven based on the low level signal 0. In contrast, the high level signal 1 transmitted through the second connection line CL2 may be transmitted to the second gate electrode 132 of the second transistor T2 through the plurality of second mode signal lines MOD2. Therefore, the plurality of second light emitting diodes ED2 may not be driven based on the high level signal 1.

As described above, the low level signal 0 which passes through the plurality of first mode signal lines MOD1 may be input to the detection circuit DC through the first detection line DEL1.

As described above, in the normal case, the first mode in which the first light emitting diode ED1 emits light may be driven based on the low level signal 0 output from the timing controller TD. Accordingly, in the display device 100 according to the example embodiment of the present disclosure, as represented in No. 1 in Table 1, if all values input to the detection circuit DC from the timing controller TD and the first detection line DEL1 are the low level signals 0, it may be interpreted as normal.

Likewise, if a value output from the timing controller TD is a high level signal 1 for operating the second mode, in the normal case, a signal which is input to the detection circuit DC through the first detection line DEL1 may also be a high level signal 1. Therefore, as represented in No. 4 of Table 1, if all values input from the timing controller TD and the first detection line DEL1 to the detection circuit DC are the high level signals 1, it may also be interpreted as normal.

In contrast, when an input value from the timing controller TD which is input to the detection circuit DC and an input value from the first detection line DEL1 are different from each other, it may be interpreted that the first mode abnormally operates.

For example, as represented in No. 2 of Table 1, if the input value transmitted from the timing controller TD is a low level signal 0 and the input value transmitted from the first detection line DEL1 is a high level signal 1, the first mode does not operate contrary to the intention, so that it can be interpreted as an abnormal operation. Further, it may also be interpreted that the level shifter LS outputs a value different from an input value input from the timing controller TD so that it may also be interpreted that the level shifter LS erroneously operates.

Likewise, as represented in No. 3 of Table 1, if the input value transmitted from the timing controller TD is a high level signal 1 and the input value transmitted from the first detection line DEL1 is a low level signal 0, the first mode operates contrary to the intention, so that it can be interpreted as an abnormal operation.

The detection circuit DC may be disposed on the printed circuit board PCB. For example, the detection circuit DC may be disposed on the printed circuit board PCB separately from the timing controller TD. The detection circuit DC may be disposed to be spaced apart from the timing controller TD. As described above, the detection circuit DC is configured separately from the timing controller TD so that the timing controller TD may be suppressed from becoming bulky.

A detection value OUT output from the detection circuit DC may be transmitted to the timing controller TD or a set unit. For example, the detection value OUT output from the detection circuit DC may be transmitted to the timing controller TD. Therefore, the timing controller TD may finally determine whether the first mode erroneously operates.

Alternatively, the detection value OUT output from the detection circuit DC may be transmitted to the set unit. At this time, the set unit may be a separate configuration from the display panel PN and the printed circuit board PCB. As described above, the detection value OUT output from the detection circuit DC is transmitted to the set unit which is separately configured to determine whether the first mode erroneously operates.

In the meantime, when the display device 100 according to the example embodiment of the present disclosure is disposed in at least a part of the dashboard of the vehicle which has been described with reference to FIG. 1 to provide a content to a user, for example, a driver and a passenger, the driver and the passenger sit side by side so that the left and right viewing angles need to be wide. However, it may distract the driver from driving the vehicle during the driving so that the content needs to be visible only to the passenger. Accordingly, it is necessary to allow the image to be visible or not to be visible to the user selectively depending on the user's request.

Therefore, the display device 100 according to the example embodiment of the present disclosure includes a first optical member 161 and a second optical member 162 having different shapes in each sub pixel RSP, GSP, or BSP. Further, the first light emitting diode ED1 and the second light emitting diode ED2 overlapping the first optical member 161 and the second optical member 162 may be driven in different modes depending on the user's needs.

For example, the first mode in which the first light emitting diode ED1 is driven may be a wide field-of view mode in which the driver and the passenger view the image together. Further, the second mode in which the second light emitting diode ED2 is driven may be a narrow field-of-view mode in which the image is not visible to the driver and only the passenger views the image. Therefore, the user may operate the second mode while the driver drives the vehicle and operate the first mode as needed when the vehicle is stopped.

As described above, in the second mode, a signal which turns off the first light emitting diode ED1 may be transmitted and in the first mode, a signal which turns on the first light emitting diode ED1 may be transmitted. In contrast, when the user drives the second mode, if the signal which turns on the first light emitting diode ED1 is erroneously transmitted, the first light emitting diode ED1 emits light, and the image may also be visible to the driver. If the image is visible to the driver while driving the vehicle, it may distract the driver from driving.

Therefore, the display device 100 according to the example embodiment of the present disclosure includes a detection circuit DC which detects a mode selection signal output from the timing controller TD and the first mode signal Ss output by the level shifter LS by the mode selection signal. The detection circuit DC receives the mode selection signal and the first mode signal Ss to determine whether the first mode signal Ss corresponding to the mode selection signal is appropriately transmitted. For example, when the timing controller TD outputs a signal for selecting the second mode, the detection circuit DC may detect whether the turn-off signal is appropriately transmitted to the first gate electrode 122 of the first transistor T1 for driving the first light emitting diode ED1.

Accordingly, the display device 100 according to the example embodiment of the present disclosure may independently detect whether the first mode appropriately operates according to the user's request.

Further, the display device 100 according to the example embodiment of the present disclosure may confirm whether the level shifter LS appropriately outputs the first mode signal as intended by the user. As described above, whether the level shifter LS normally operates may be independently detected.

Therefore, the erroneous operations of the level shifter LS and the first mode are independently and promptly detected so that the image may be suppressed from unnecessarily being visible to the driver. As described above, the image is suppressed from being visible to the user while driving the vehicle so that the safety of the vehicle driving may be enhanced.

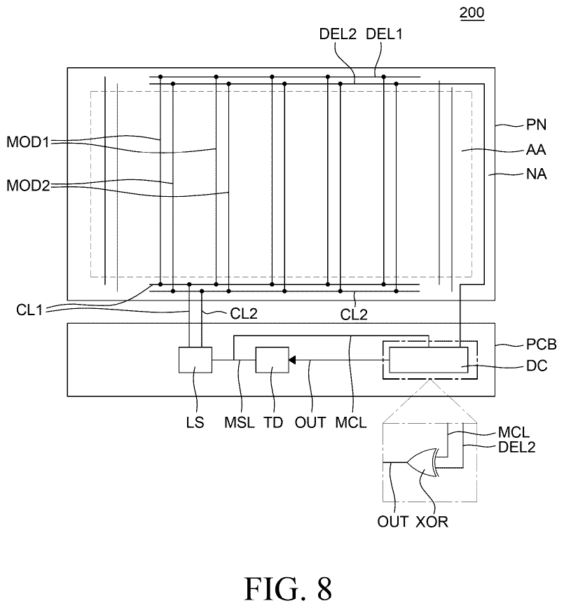

FIG. 8 is a schematic plan view of a display device according to another example embodiment of the present disclosure.

FIG. 8 is an enlarged plan view schematically illustrating a configuration of a display panel PN and a printed circuit board PCB of a display device 200 according to another example embodiment of the present disclosure. A display device 200 of FIG. 8 has substantially the same configuration as the display device 100 of FIGS. 1 to 7 except for a second detection line DEL2 and a detection circuit DC, so that a redundant description will be omitted.

Referring to FIG. 8, the plurality of first mode signal lines MOD1 may be connected to the first detection line DEL1 in the non-active area NA. For example, the first detection line DEL1 may be connected to the plurality of first mode signal lines MOD1 in the non-active area NA located above the display panel PN, but is not limited thereto. In the display device 200 according to another example embodiment of the present disclosure, the first detection line DEL1 may be omitted as needed.

The plurality of second mode signal lines MOD2 may be connected to the second detection line DEL2. Further, the second detection line DEL2 may be connected to the detection circuit DC. Therefore, the second mode signal Ps may be transmitted to the detection circuit DC through the second detection line DEL2.

The second detection line DEL2 may be disposed in the non-active area NA. For example, the second detection line DEL2 may be connected to the plurality of second mode signal lines MOD2 in the non-active area NA located in the upper area of the display panel PN. Further, the second detection line DEL2 extends along the non-active area NA located in a side portion of the display panel PN to be connected to the detection circuit DC, but is not limited thereto.

The detection circuit DC receives the second mode signal Ps from the second detection line DEL2. The detection circuit DC serves to detect whether the level shifter LS and the second mode normally operate based on the received second mode signal Ps.

For example, the detection circuit DC may be electrically connected to a mode selection signal line MSL through a mode selection connection line MCL. Therefore, the detection circuit DC may receive a mode selection signal output from the timing controller TD through the mode selection connection line MCL.

As described above, the detection circuit DC receives the second mode signal Ps transmitted from the second detection line DEL2 and a mode selection signal transmitted from the mode selection connection line MCL to confirm a normal operation of the level shifter LS and the second mode. For example, the detection circuit DC may include an exclusive OR (XOR) gate XOR as represented in a truth table of the following Table 2.

TABLE 2

| | Input (IN) | | Output | |
|---|---|---|---|---|
| | Mode selection signal | Second mode signal | (OUT) | Result |
| 1 | 0 | 0 | 0 | Abnormal |
| 2 | 0 | 1 | 1 | Normal |
| 3 | 1 | 0 | 1 | Normal |
| 4 | 1 | 1 | 0 | Abnormal |

Referring to Table 2 together, in the display device 200 according to another example embodiment of the present disclosure, a mode selection signal which is a low level signal 0 or a high level signal 1 may be output from the timing controller TD. At this time, the low level signal 0 may be a signal for driving the first mode and the high level signal 1 may be a signal for driving the second mode, but the present disclosure is not limited thereto.

When the high level signal 1 is output from the timing controller TD, the high level signal 1 may be transmitted to the level shifter LS through the mode selection signal line MSL. Further, the high level signal 1 output from the timing controller TD may be input to the detection circuit DC through the mode selection signal connection line MCL.

In a normal case, if the high level signal 1 is input to the level shifter LS, the high level signal 1 may be output to the first connection line CL1 and the low level signal 0 may be output to the second connection line CL2. The high level signal 1 transmitted through the first connection line CL1 may be transmitted to the first gate electrode 122 of the first transistor T1 through the plurality of first mode signal lines MOD1. Therefore, the plurality of first light emitting diodes ED1 may not be driven based on the high level signal 1. In contrast, the low level signal 0 transmitted through the second connection line CL2 may be transmitted to the second gate electrode 132 of the second transistor T2 through the plurality of second mode signal lines MOD2. Therefore, the plurality of second light emitting diodes ED2 may be driven based on the low level signal 0.

As described above, the low level signal 0 which passes through the plurality of second mode signal lines MOD2 may be input to the detection circuit DC through the second detection line DEL2.

As described above, in the normal case, the second mode in which the second light emitting diode ED2 emits light may be driven based on the high level signal 1 output from the timing controller TD. Accordingly, in the display device 200 according to the example embodiment of the present disclosure, as represented in No. 3 in Table 2, if all values input to the detection circuit DC from the timing controller TD and the second detection line DEL2 are different from each other, it may be interpreted as normal.

Likewise, if a value output from the timing controller TD is a low level signal 0 for driving the first mode, a signal which is input to the detection circuit DC through the second detection line DEL2 may also be a high level signal 1. Therefore, as represented in No. 2 of Table 2, if all values input from the timing controller TD and the second detection line DEL2 to the detection circuit DC are different from each other, it may also be interpreted as normal.

In contrast, when an input value from the timing controller TD which is input to the detection circuit DC and an input value from the second detection line DEL2 are equal to each other, it may be interpreted that the second mode abnormally operates.

For example, as represented in No. 1 of Table 2, if both the input value transmitted from the timing controller TD and the input value transmitted from the second detection line DEL2 are low level signals 0, the second mode operates contrary to the intention, so that it can be interpreted as an abnormal operation. Further, it may also be interpreted that the level shifter LS outputs a value different from an input value input from the timing controller TD so that it may be interpreted that the level shifter LS erroneously operates.

Likewise, as represented in No. 4 of Table 2, if both the input value transmitted from the timing controller TD and the input value transmitted from the second detection line DEL2 are high level signals 1, the second mode does not operate contrary to the intention, so that it can be interpreted as an abnormal operation.

As described above, the display device 200 according to the example embodiment of the present disclosure includes a first optical member 161 and a second optical member 162 having different shapes in each sub pixel RSP, GSP, or BSP to operate in various modes according to the user's needs.

For example, the first mode in which the first light emitting diode ED1 is driven may be a wide field-of view mode in which the driver and the passenger view the image together. Further, the second mode in which the second light emitting diode ED2 is driven may be a narrow field-of-view mode in which the image is not visible to the driver and only the passenger views the image. Therefore, the user may operate the second mode while the driver drives the vehicle and operate the first mode as needed when the vehicle is stopped.

Therefore, the display device 200 according to another example embodiment of the present disclosure includes a detection circuit DC which detects a mode selection signal output from the timing controller TD and the second mode signal Ps output by the level shifter LS by the mode selection signal. The detection circuit DC receives the mode selection signal and the second mode signal Ps to determine whether the second mode signal Ps corresponding to the mode selection signal is appropriately transmitted. For example, when the timing controller TD outputs a signal for selecting the second mode, the detection circuit DC may detect whether the turn-on signal is appropriately transmitted to the second gate electrode 132 of the second transistor T2 for driving the second light emitting diode ED2.

Accordingly, the display device 200 according to another example embodiment of the present disclosure may independently detect whether the second mode appropriately operates according to the user's request.

Further, the display device 200 according to another example embodiment of the present disclosure may confirm whether the level shifter LS appropriately outputs the second mode signal as intended by the user. As described above, whether the level shifter LS normally operates may be independently detected.

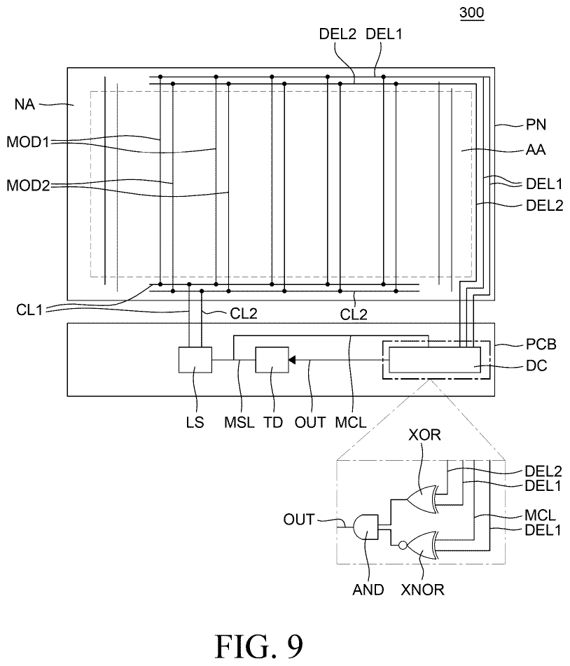

FIG. 9 is a schematic plan view of a display device according to still another example embodiment of the present disclosure.

FIG. 9 is an enlarged plan view schematically illustrating a configuration of a display panel PN and a printed circuit board PCB of a display device 300 according to still another example embodiment of the present disclosure. A display device 300 of FIG. 9 has substantially the same configuration as the display device 100 of FIGS. 1 to 7 except for a first detection line DEL1, a second detection line DEL2 and a detection circuit DC, so that a redundant description will be omitted.

Referring to FIG. 9, the plurality of first mode signal lines MOD1 may be connected to the first detection line DEL1 in the non-active area NA. For example, the first detection line DEL1 may be connected to the plurality of first mode signal lines MOD1 in the non-active area NA located above the display panel PN. Further, the first detection line DEL1 extends along the non-active area NA located in a side portion of the display panel PN to be connected to the detection circuit DC. Therefore, the first mode signal Ss may be transmitted to the detection circuit DC through the first detection line DEL1.

At this time, a plurality of first detection lines DEL1 may be connected to the detection circuit DC. For example, the plurality of first detection lines DEL1 extending from the upper portion of the display panel PN may be connected to the detection circuit DC.

The plurality of second mode signal lines MOD2 may be connected to the second detection line DEL2. Further, the second detection line DEL2 may be connected to the detection circuit DC. Therefore, the second mode signal Ps may be transmitted to the detection circuit DC through the second detection line DEL2.

The second detection line DEL2 may be disposed in the non-active area NA. For example, the second detection line DEL2 may be connected to the plurality of second mode signal lines MOD2 in the non-active area NA located in the upper area of the display panel PN. Further, the second detection line DEL2 extends along the non-active area NA located in a side portion of the display panel PN to be connected to the detection circuit DC, but is not limited thereto.

The detection circuit DC may be connected to the first detection line DEL1 and the second detection line DEL2. Therefore, the detection circuit DC may receive the first mode signal Ss through the first detection line DEL1 and receive the second mode signal Ps through the second detection line DEL2.

Further, the detection circuit DC may be electrically connected to the mode selection signal line MSL through the mode selection connection line MCL. Therefore, the detection circuit DC may receive a mode selection signal output from the timing controller TD through the mode selection connection line MCL.

The detection circuit DC may include an XNOR gate XNOR which receives the first mode signal Ss transmitted from the first detection line DEL1 and the mode selection signal transmitted from the mode selection connection line MCL. The XNOR gate XNOR is connected to the first detection line DEL1 and the mode selection signal to serve to detect whether the level shifter LS and the first mode normally operate. The XNOR gate XNOR is substantially the same as the XNOR gate XNOR of the display device 100 of FIGS. 1 to 7, so that a redundant description will be omitted.

Further, the detection circuit DC may include an XOR gate XOR which receives the first mode signal Ss transmitted from the first detection line DEL1 and the second mode signal Ps transmitted from the second detection line DEL2. For example, the truth table of the XOR gate XOR may be as represented in Table 3.

TABLE 3

| | Input (IN) | | Output | |
|---|---|---|---|---|
| | First mode signal | Second mode signal | (OUT) | Result |
| 1 | 0 | 0 | 0 | Abnormal |
| 2 | 0 | 1 | 1 | Normal |
| 3 | 1 | 0 | 1 | Normal |
| 4 | 1 | 1 | 0 | Abnormal |

Referring to Table 3 together, if the low level signal 0 for driving the first mode is output from the timing controller TD, in the normal case, the low level signal 0 may be output from the level shifter LS to the first connection line CL1 and the high level signal 1 may be output to the second connection line CL2. Therefore, as represented in No. 2 of Table 3, the XOR gate XOR may receive the low level signal 0 from the first detection line DEL1 and receive the high level signal 1 from the second detection line DEL2. In this case, the XOR gate XOR may output the high level signal 1 which is a normal signal.

Likewise, as represented in No. 3 of Table 3, if the high level signal 1 for driving the second mode is output from the timing controller TD, in the normal case, the high level signal 1 may be output from the level shifter LS to the first connection line CL1 and the low level signal 0 may be output to the second connection line CL2. Therefore, the XOR gate XOR may receive the high level signal 1 from the first detection line DEL1 and receive the low level signal 0 from the second detection line DEL2. In this case, the XOR gate XOR may output the high level signal 1 which is a normal signal.

As described above, in the normal case, different signals may be transmitted to the first detection line DEL1 and the second detection line DEL2.

In contrast, as represented in Nos. 1 and 4 of Table 3, if input values received from the first detection line DEL1 and the second detection line DEL2 are equal to each other, it may be interpreted that the first mode or the second mode does not normally operate contrary to the user's intention. Therefore, the XOR gate XOR may output the low level signal 0 which is an abnormal signal.

As described above, the XOR gate XOR is connected to the first detection line DEL1 and the second detection line DEL2 to detect whether the level shifter LS normally operates.

Together with this, the detection circuit DC may include an AND gate AND which receives the output signals output from the XNOR gate XNOR and the XOR gate XOR to have a truth table as represented in Table 4.

TABLE 4

| | Input (IN) | | Output | |
|---|---|---|---|---|
| | XOR gate output | XNOR gate output | (OUT) | Result |
| 1 | 0 | 0 | 0 | Abnormal |
| 2 | 0 | 1 | 0 | Abnormal |
| 3 | 1 | 0 | 0 | Abnormal |
| 4 | 1 | 1 | 1 | Normal |

Referring to Table 4 together, the AND gate AND receives the output signals output from the XOR gate XOR and the XNOR gate XNOR to detect whether the level shifter LS and the first mode normally operate.

For example, if the level shifter LS normally operates so that the first mode normally operates as intended by the user, both the XOR gate XOR and the XNOR gate XNOR may output the high level signals 1 which are normal signals. Therefore, as represented in No. 4 of Table 4, when the high level signals 1 are input to the AND gate AND from the XOR gate XOR and the XNOR gate XNOR, it may be finally interpreted that the level shifter LS and the first mode normally operate.

In contrast, if any one of the low level signal 0 which is an abnormal signal is input to the AND gate AND, it may be interpreted that the level shifter LS and the first mode do not normally operate.

The display device 300 according to still another example embodiment of the present disclosure includes a first optical member 161 and a second optical member 162 having different shapes in each sub pixel RSP, GSP, or BSP to operate in various modes according to the user's needs.

For example, the first mode in which the first light emitting diode ED1 is driven may be a wide field-of view mode in which the driver and the passenger view the image together. Further, the second mode in which the second light emitting diode ED2 is driven may be a narrow field-of-view mode in which the image is not visible to the driver and only the passenger views the image. Therefore, the user may operate the second mode while the driver drives the vehicle and operate the first mode as needed when the vehicle is stopped.

Further, the display device 300 according to still another example embodiment of the present disclosure includes a plurality of gates to independently detect whether the level shifter LS normally outputs the first mode signal Ss or the second mode signal Ps according to the mode selection signal output from the timing controller TD. As described above, the display device 300 according to still another example embodiment of the present disclosure may independently detect whether the level shifter LS erroneously operates.

The display device 300 according to still another example embodiment of the present disclosure may independently detect whether the first mode normally operates according to the user's intention. Therefore, whether the first mode erroneously operates is quickly detected to suppress the image from being unnecessarily visible to the user. As described above, the image is suppressed from being visible to the user while driving the vehicle so that the safety of the vehicle driving may be enhanced.

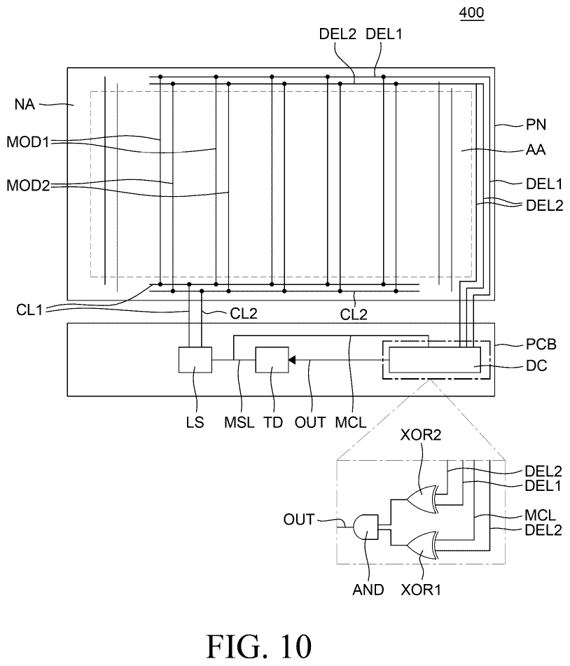

FIG. 10 is a schematic plan view of a display device according to still another example embodiment of the present disclosure.

FIG. 10 is an enlarged plan view schematically illustrating a configuration of a display panel PN and a printed circuit board PCB of a display device 400 according to still another example embodiment of the present disclosure. A display device 400 of FIG. 10 has substantially the same configuration as the display device 100 of FIGS. 1 to 7 except for a first detection line DEL1, a second detection line DEL2 and a detection circuit DC, so that a redundant description will be omitted.

Referring to FIG. 10, the plurality of first mode signal lines MOD1 may be connected to the first detection line DEL1 in the non-active area NA. For example, the first detection line DEL1 may be connected to the plurality of first mode signal lines MOD1 in the non-active area NA located above the display panel PN. Further, the first detection line DEL1 extends along the non-active area NA located in a side portion of the display panel PN to be connected to the detection circuit DC. Therefore, the first mode signal Ss may be transmitted to the detection circuit DC through the first detection line DEL1.

The plurality of second mode signal lines MOD2 may be connected to the second detection line DEL2. Further, the second detection line DEL2 may be connected to the detection circuit DC. Therefore, the second mode signal Ps may be transmitted to the detection circuit DC through the second detection line DEL2.

The second detection line DEL2 may be disposed in the non-active area NA. For example, the second detection line DEL2 may be connected to the plurality of second mode signal lines MOD2 in the non-active area NA located in the upper area of the display panel PN. Further, the second detection line DEL2 extends along the non-active area NA located in a side portion of the display panel PN to be connected to the detection circuit DC. At this time, a plurality of second detection lines DEL2 may be connected to the detection circuit DC. For example, the plurality of second detection lines DEL2 extending from the upper portion of the display panel PN may be connected to the detection circuit DC.

The detection circuit DC may be connected to the first detection line DEL1 and the second detection line DEL2. Therefore, the detection circuit DC may receive the first mode signal Ss through the first detection line DEL1 and receive the second mode signal Ps through the second detection line DEL2.

Further, the detection circuit DC may be electrically connected to the mode selection signal line MSL through the mode selection connection line MCL. Therefore, the detection circuit DC may receive a mode selection signal output from the timing controller TD through the mode selection connection line MCL.

The detection circuit DC may include a first XOR gate XOR1 which receives the second mode signal Ps transmitted from the second detection line DEL2 and the mode selection signal transmitted from the mode selection connection line MCL. Further, the detection circuit DC may include a second XOR gate XOR2 which receives the first mode signal Ss transmitted from the first detection line DEL1 and the second mode signal Ps transmitted from the second detection line DEL2.

At this time, the first XOR gate XOR1 is substantially the same as the XOR gate XOR of the display device 200 of FIG. 8. Further, the second XOR gate XOR2 is substantially the same as the XOR gate XOR of the display device 300 of FIG. 9 so that a redundant description will be omitted.

The detection circuit DC may include an AND gate AND which receives output signals output from the first XOR gate XOR1 and the second XOR gate XOR2 to have a truth table as represented in Table 5.

TABLE 5

| | Input (IN) | | | |
|---|---|---|---|---|
| | | Second XOR gate | Output | |
| | First XOR gate output | output | (OUT) | Result |
| 1 | 0 | 0 | 0 | Abnormal |
| 2 | 0 | 1 | 0 | Abnormal |
| 3 | 1 | 0 | 0 | Abnormal |
| 4 | 1 | 1 | 1 | Normal |

Referring to Table 5 together, the AND gate AND receives the output signals output from the first XOR gate XOR1 and the second XOR gate XOR2 to detect whether the level shifter LS and the second mode normally operate.

For example, if the level shifter LS normally operates so that the second mode normally operates as intended by the user, both the first XOR gate XOR1 and the second XOR gate XOR2 may output the high level signals 1 which are normal signals. Accordingly, as represented in No. 4 of Table 5, when the high level signals 1 are input to the AND gate AND from the first XOR gate XOR1 and the second XOR gate XOR2, it may be finally interpreted that the level shifter LS and the second mode normally operate.

In contrast, as represented in Nos. 1 to 4 of Table 5, if any one of the low level signal 0 which is an abnormal signal is input to the AND gate AND, it may be interpreted that the level shifter LS and the second mode do not normally operate.

A display device 400 according to still another example embodiment of the present disclosure includes a first optical member 161 and a second optical member 162 having different shapes in each sub pixel RSP, GSP, or BSP to operate in various modes according to the user's needs.

For example, the first mode in which the first light emitting diode ED1 is driven may be a wide field-of view mode in which the driver and the passenger view the image together. Further, the second mode in which the second light emitting diode ED2 is driven may be a narrow field-of-view mode in which the image is not visible to the driver and only the passenger views the image. Therefore, the user may operate the second mode while the driver drives the vehicle and operate the first mode as needed when the vehicle is stopped.

Further, the display device 400 according to still another example embodiment of the present disclosure includes a plurality of gates to independently detect whether the level shifter LS normally outputs the first mode signal Ss or the second mode signal Ps according to the mode selection signal output from the timing controller TD. As described above, the display device 400 according to still another example embodiment of the present disclosure may independently detect whether the level shifter LS erroneously operates.

Further, the display device 400 according to still another example embodiment of the present disclosure may independently detect whether the second mode appropriately operates according to the user's request.

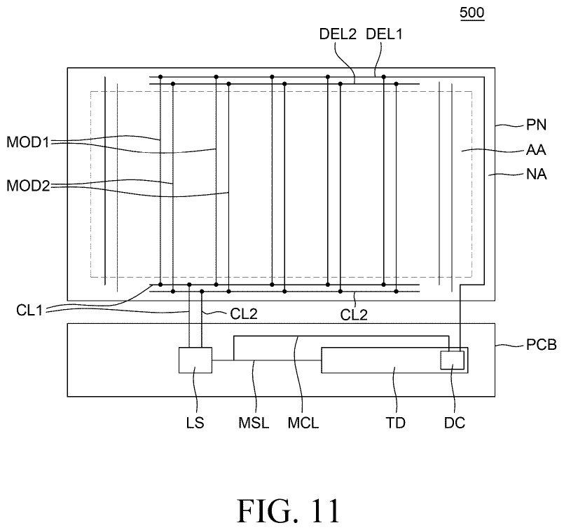

FIG. 11 is a schematic plan view of a display device according to still another example embodiment of the present disclosure.

FIG. 11 is an enlarged plan view schematically illustrating a configuration of a display panel PN and a printed circuit board PCB of a display device 500 according to still another example embodiment of the present disclosure. A display device 500 of FIG. 11 has substantially the same configuration as the display device 100 of FIGS. 1 to 7 except for a detection circuit DC, so that a redundant description will be omitted.

Referring to FIG. 11, the detection circuit DC may be integrated with the timing controller TD. For example, the detection circuit DC may be included as one configuration of the timing controller TD. Therefore, the detection circuit DC may be internalized in the timing controller TD.

As described above, when the detection circuit DC is internalized in the timing controller TD, the timing controller TD may independently process an output value output from the detection circuit DC.

A display device 500 according to still another example embodiment of the present disclosure includes a first optical member 161 and a second optical member 162 having different shapes in each sub pixel RSP, GSP, or BSP to be driven in various modes according to the user's needs.

For example, the first mode in which the first light emitting diode ED1 is driven may be a wide field-of view mode in which the driver and the passenger view the image together. Further, the second mode in which the second light emitting diode ED2 is driven may be a narrow field-of-view mode in which the image is not visible to the driver and only the passenger views the image. Therefore, the user may operate the second mode while the driver drives the vehicle and operate the first mode as needed when the vehicle is stopped.

Further, the display device 500 according to still another example embodiment of the present disclosure includes a plurality of gates to independently detect whether the level shifter LS normally outputs the first mode signal Ss or the second mode signal Ps according to the mode selection signal output from the timing controller TD. As described above, the display device 500 according to still another example embodiment of the present disclosure may independently detect whether the level shifter LS erroneously operates.

The display device 500 according to still another example embodiment of the present disclosure may independently detect whether the first mode normally operates according to the user's intention. Therefore, whether the first mode erroneously operates is quickly detected to suppress the image from being unnecessarily visible to the user. As described above, the image is suppressed from being visible to the user while driving the vehicle so that the safety of the vehicle driving may be enhanced.

The example embodiments of the present disclosure can also be described as follows:

A display device according to an aspect of the present disclosure, comprises a timing controller for outputting a mode selection signal, a level shifter for outputting a first mode signal and a second mode signal based on the mode selection signal, a first light emitting diode configured to be driven based on the first mode signal, a first optical member disposed on the first light emitting diode, a second light emitting diode configured to be driven based on the second mode signal, a second optical member disposed on the second light emitting diode and having a shape different from a shape of the first optical member and a detection circuit configured to detect whether the level shift, a first mode or a second mode operates normally based on at least two of the first mode signal, the second mode signal and the mode selection signal.

The detection circuit may include an XNOR gate for receiving the mode selection signal and the first mode signal.

The detection circuit may include an XOR gate for receiving the mode selection signal and the second mode signal.

The detection circuit may include an XNOR gate for receiving the mode selection signal and the first mode signal, an XOR gate for receiving the first mode signal and the second mode signal, and an AND gate for receiving output signals of the XNOR gate and the XOR gate.

The detection circuit may include a first XOR gate for receiving the mode selection signal and the second mode signal, a second XOR gate for receiving the first mode signal and the second mode signal, and an AND gate for receiving output signals of the first XOR gate and the second XOR gate.

The detection circuit may transmit a detection value regarding whether the level shift, the first mode or the second mode normally operate to the timing controller or a set unit.

The display device may further comprise a printed circuit board on which the timing controller is disposed, wherein the detection circuit may be integrated with the timing controller or is disposed on the printed circuit board.

The display device may further comprise a first connection line for transmitting the first mode signal output from the level shifter, a first mode signal line connected to the first connection line and for transmitting the first mode signal to the first light emitting diode, and a first detection line connected to the first mode signal line and for transmitting the first mode signal to the detection circuit.

The first connection line and the first detection line may be disposed in a non-active area and at least a part of the first mode signal line overlaps an active area.

The display device may further comprise a second connection line for transmitting the second mode signal output from the level shifter, a second mode signal line connected to the second connection line and for transmitting the second mode signal to the second light emitting diode, and a second detection line connected to the second mode signal line and for transmitting the second mode signal to the detection circuit.

The second connection line and the second detection line may be disposed in a non-active area and at least a part of the second mode signal line overlaps an active area.

A display device according to another aspect of the present disclosure comprise a timing controller for outputting a mode selection signal, a mode selection signal line for transmitting the mode selection signal, a level shifter connected to the mode selection signal line and for outputting a first mode signal and a second mode signal, a first connection line for transmitting the first mode signal, a second connection line for transmitting the second mode signal, a plurality of first mode signal lines connected to the first connection line and for transmitting the first mode signal to the plurality of first light emitting diodes, a plurality of second mode signal lines connected to the second connection line and for transmitting the second mode signal to the plurality of second light emitting diodes, a plurality of first optical members disposed so as to correspond to the plurality of first light emitting diodes, a plurality of second optical members disposed so as to correspond to the plurality of second light emitting diodes, one or more detection lines among a first detection line connected to the plurality of first mode signal lines to transmit the first mode signal to a detection circuit and a second detection line connected to the plurality of second mode signal lines to transmit the second mode signal to the detection circuit, and the detection circuit for receiving at least one of the first mode signal and the second mode signal from the one or more detection lines.

The detection circuit may include an XNOR gate connected to the mode selection signal line and the first detection line.

The detection circuit may include an XOR gate connected to the mode selection signal line and the second detection line.

The detection circuit may include an XNOR gate connected to the mode selection signal line and the first detection line, an XOR gate to the first detection line and the second detection line, and an AND gate electrically connected to the XNOR gate and the XOR gate.

The detection circuit may include a first XOR gate connected to the mode selection signal line and the second detection line, a second XOR gate connected to the first connection line and the second connection line, and an AND gate electrically connected to the first XOR gate and the second XOR gate.

The detection circuit may transmit a detection value to the timing controller or a set unit.

The display device may further comprise a printed circuit board on which the timing controller is disposed, wherein the detection circuit is integrated with the timing controller or is disposed on the printed circuit board.

Although the example embodiments of the present disclosure have been described in detail with reference to the accompanying drawings, the present disclosure is not limited thereto and may be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure. All the technical concepts in the equivalent scope of the present disclosure should be construed as falling within the scope of the present disclosure.

What is claimed is:

1. A display device, comprising:
a timing controller for outputting a mode selection signal;
a level shifter for outputting a first mode signal and a second mode signal based on the mode selection signal;
a first light emitting diode configured to be driven based on the first mode signal;
a first optical member disposed on the first light emitting diode;
a second light emitting diode configured to be driven based on the second mode signal;
a second optical member disposed on the second light emitting diode and having a shape different from a shape of the first optical member; and
a detection circuit configured to detect whether the level shift, a first mode or a second mode operates normally based on at least two of the first mode signal, the second mode signal and the mode selection signal.

2. The display device according to claim 1, wherein the detection circuit includes an XNOR gate for receiving the mode selection signal and the first mode signal.

3. The display device according to claim 1, wherein the detection circuit includes an XOR gate for receiving the mode selection signal and the second mode signal.

4. The display device according to claim 1, wherein the detection circuit includes:
an XNOR gate for receiving the mode selection signal and the first mode signal;
an XOR gate for receiving the first mode signal and the second mode signal; and
an AND gate for receiving output signals of the XNOR gate and the XOR gate.

5. The display device according to claim 1, wherein the detection circuit includes:
a first XOR gate for receiving the mode selection signal and the second mode signal;
a second XOR gate for receiving the first mode signal and the second mode signal; and
an AND gate for receiving output signals of the first XOR gate and the second XOR gate.

6. The display device according to claim 1, wherein the detection circuit is configured to transmit a detection value regarding whether the level shift, the first mode or the second mode operates normally to the timing controller or a set unit.

7. The display device according to claim 1, further comprising:
a printed circuit board on which the timing controller is disposed,
wherein the detection circuit is integrated with the timing controller or is disposed on the printed circuit board.

8. The display device according to claim 1, further comprising:
a first connection line for transmitting the first mode signal output from the level shifter;
a first mode signal line connected to the first connection line and for transmitting the first mode signal to the first light emitting diode; and
a first detection line connected to the first mode signal line and for transmitting the first mode signal to the detection circuit.

9. The display device according to claim 8, wherein the first connection line and the first detection line are disposed in a non-active area, and at least a part of the first mode signal line overlaps an active area.

10. The display device according to claim 1, further comprising:
a second connection line for transmitting the second mode signal output from the level shifter;
a second mode signal line connected to the second connection line and for transmitting the second mode signal to the second light emitting diode; and
a second detection line connected to the second mode signal line and for transmitting the second mode signal to the detection circuit.

11. The display device according to claim 10, wherein the second connection line and the second detection line are disposed in a non-active area, and at least a part of the second mode signal line overlaps an active area.

12. A display device, comprising:
a timing controller for outputting a mode selection signal;
a mode selection signal line for transmitting the mode selection signal;
a level shifter connected to the mode selection signal line and for outputting a first mode signal and a second mode signal;
a first connection line for transmitting the first mode signal;
a second connection line for transmitting the second mode signal;
a plurality of first mode signal lines connected to the first connection line and for transmitting the first mode signal to the plurality of first light emitting diodes;
a plurality of second mode signal lines connected to the second connection line and for transmitting the second mode signal to the plurality of second light emitting diodes;
a plurality of first optical members disposed so as to correspond to the plurality of first light emitting diodes;
a plurality of second optical members disposed so as to correspond to the plurality of second light emitting diodes;
one or more detection lines among a first detection line connected to the plurality of first mode signal lines to transmit the first mode signal to a detection circuit and a second detection line connected to the plurality of second mode signal lines to transmit the second mode signal to the detection circuit; and
the detection circuit for receiving at least one of the first mode signal and the second mode signal from the one or more detection lines.

13. The display device according to claim 12, wherein the detection circuit includes an XNOR gate connected to the mode selection signal line and the first detection line.

14. The display device according to claim 12, wherein the detection circuit includes an XOR gate connected to the mode selection signal line and the second detection line.

15. The display device according to claim 12, wherein the detection circuit includes:
an XNOR gate connected to the mode selection signal line and the first detection line;
an XOR gate connected to the first detection line and the second detection line; and
an AND gate electrically connected to the XNOR gate and the XOR gate.

16. The display device according to claim 12, wherein the detection circuit includes:
a first XOR gate connected to the mode selection signal line and the second detection line;
a second XOR gate connected to the first connection line and the second connection line; and
an AND gate electrically connected to the first XOR gate and the second XOR gate.

17. The display device according to claim 12, wherein the detection circuit is configured to transmit a detection value to the timing controller or a set unit.

18. The display device according to claim 12, further comprising:
a printed circuit board on which the timing controller is disposed,
wherein the detection circuit is integrated with the timing controller or is disposed on the printed circuit board.
